(19) United States
(12) Patent Application Publication
(10) Pub. No.: US 2013/0304860 A1
(43) Pub. Date: Nov. 14, 2013

(54) METHOD AND APPARATUS FOR CONTROLLING THE TRANSCEIVING OF CONTENT

(71) Applicants: Seungryul Yang, Seoul (KR); Minsoo Lee, Seoul (KR); Jangwoong Park, Seoul (KR); Beomjin Jeon, Seoul (KR); Jongyeop Lee, Seoul (KR)

(72) Inventors: Seungryul Yang, Seoul (KR); Minsoo Lee, Seoul (KR); Jangwoong Park, Seoul (KR); Beomjin Jeon, Seoul (KR); Jongyeop Lee, Seoul (KR)

(73) Assignee: LG ELECTRONICS INC., Seoul (KR)

(21) Appl. No.: 13/979,990

(22) PCT Filed: Jan. 17, 2012
(86) PCT No.: PCT/KR2012/000398

§ 371 Date: Jul. 16, 2013

Related U.S. Application Data
(60) Provisional application No. 61/433,275, filed on Jan. 17, 2011.
(60) Provisional application No. 61/453,545, filed on Mar. 17, 2011.
(60) Provisional application No. 61/470,452, filed on Mar. 31, 2011.
(60) Provisional application No. 61/525,829, filed on Aug. 21, 2011.
(60) Provisional application No. 61/527,085, filed on Aug. 24, 2011.
(60) Provisional application No. 61/537,037, filed on Sep. 20, 2011.
(60) Provisional application No. 61/560,241, filed on Nov. 15, 2011.

(51) Int. Cl. H04L 29/06

(52) U.S. Cl. CPC H04L 65/60
USPC 709/217

(57) ABSTRACT

Provided is a method of controlling content transmission between Universal Plug and Play (UPnP) devices. The method comprise discovering a plurality of UPnP devices; receiving, from at least one of the discovered UPnP devices, a Consumer Electronics Control (CEC) address of the UPnP device and a CEC address of a device which is connected to the UPnP device through a High Definition Multimedia Interface (HDMI); checking, by using the received CEC addresses, an HDMI connection between a source device and a sink device among the discovered UPnP devices; and controlling content to be streamed through the HDMI connection between the source device and the sink device.

### TECHNICAL FIELD

The present disclosure relates to a method of controlling AV content transmission between Universal Plug and Play (UPnP) devices.

### BACKGROUND ART

The universal plug and play (UPnP) technology and the digital living network alliance (DLNA) technology allow controls and services between home appliances of various manufacturers. Especially, the UPnP technology and DLNA technology allow compatible AV service and control between audio-visual (AV) devices. As the compatible AV service, there are media streaming, uploading, and downloading.

DLNA, as a home network device, regulates a digital media server (DMS), a digital media player (DMP), a digital media renderer (DMR), a digital media controller (DMC), and a digital media printer (DMPr), and, as a mobile portable device, regulates a mobile digital media server (M-DMS), a mobile digital media player (M-DMP), a mobile digital media uploader (M-DMU), a mobile digital media downloader (M-DMD), and a mobile digital media controller (M-DMC).

The UPnP classifies such devices into control point (CP) devices and control target devices. The DMC and the DMP are classified into the CP devices, and the DMR, the DMS, and DMPr are classified into control target devices.

### DISCLOSURE OF THE INVENTION

### Technical Problem

Embodiments provide a method of controlling AV transmission to efficiently service AV content between UPnP devices and a control device using the same.

### Technical Solution

In one embodiment, provided is a method of controlling content transmission between Universal Plug and Play (UPnP) devices. The method comprise discovering a plurality of UPnP devices; receiving, from at least one of the discovered UPnP devices, a Consumer Electronics Control (CEC) address of the UPnP device and a CEC address of a device which is connected to the UPnP device through a High Definition Multimedia Interface (HDMI); ckecking, by using the received CEC addresses, an HDMI connection between a source device and a sink device among the discovered UPnP devices; and controlling content to be streamed through the HDMI connection between the source device and the sink device.

In another embodiment, provided is a device of controlling content transmission between UPnP devices. The device comprises a communication unit receiving CEC address information from at least one of discovered UPnP devices; and a controller checking an HDMI connection between a source device and a sink device among the discovered UPnP devices by using the received CEC address information and controlling a content to be streamed through the HDMI connection between the source device and the sink device, wherein the CEC address information comprises a CEC address of the UPnP device and a CEC address of a device connected to the UPNP device through an HDMI.

### Advantageous Effects

According to an embodiment of the present invention, AV service is efficiently provided by allowing content transmission with an HDMI interface between UPnP devices, and also adaptive content streaming is possible based on a network state.

### BRIEF DESCRIPTION OF THE DRAWINGS

FIG. 1 is a block diagram illustrating a configuration of an UPnP network according to an embodiment of the present invention.

FIG. 2 is a block diagram illustrating a configuration of a content transmitting/receiving system according to an embodiment of the present invention.

FIG. 3 is a flowchart illustrating a method of transmitting/receiving content according to an embodiment of the present invention.

FIG. 4 is a ladder diagram illustrating a method of receiving CEC address information of UPnP devices according to a first embodiment of the present invention.

FIG. 5 is a view illustrating an action defined to request CEC address information according to an embodiment of the present invention.

FIGS. 6 to 13 are views illustrating device information discovered by a CP.

FIG. 14 is a block diagram illustrating a configuration of a content transmitting/receiving system according to another embodiment of the present invention.

FIG. 15 is a view illustrating device information discovered by a CP in the case of the 2 box model shown in FIG. 14.

FIG. 16 is a block diagram illustrating a configuration of a content transmitting/receiving system according to another embodiment of the present invention.

FIGS. 17 to 22 are views illustrating device information discovered by a CP in the case of the system of FIG. 14.

FIG. 23 is a ladder diagram illustrating a method of receiving CEC address information of UPnP devices according to a second embodiment of the present invention.

FIG. 24 is a view illustrating protocol information received by a CP according to an embodiment of the present invention.

FIGS. 25 and 26 are views illustrating a method of checking an HDMI connection between a source device and a sink device according to an embodiment of the present invention.

FIGS. 27 and 28 are views illustrating a method of turning on an HDMI session between a source device and a sink device according to a first embodiment of the present invention.

FIGS. 29 and 31 are views illustrating a method of turning on an HDMI session between a source device and a sink device according to a second embodiment of the present invention.

FIG. 32 is a ladder diagram illustrating a method of controlling content streaming through an HDMI connection according to a first embodiment of the present invention.

FIG. 33 is a ladder diagram illustrating a method of controlling content streaming through an HDMI connection according to a second embodiment of the present invention.

FIGS. 34 to 38 are views illustrating a method of checking whether UPnP devices can decode content according to embodiments of the present invention.

FIG. 39 is a block diagram illustrating a method of relaying content streaming according to an embodiment of the present invention.

FIGS. 40 and 41 are block diagrams illustrating a configuration of a source device according to embodiments of the present invention.

FIG. 42 is a block diagram illustrating a configuration of a control device according to an embodiment of the present invention.

FIGS. 43 to 51 are views illustrating a method of determining an interface for transmitting/receiving content according to embodiments of the present invention.

### MODE FOR CARRYING OUT THE INVENTION

Desired embodiments of the present invention to specifically realize objects hereinafter are described with reference to the accompanying drawings. At this point, configurations and actions of the present invention shown in the drawings and described using the same are described as at least one embodiment. The technical ideas of the present invention and its core configuration and action are not limited thereto.

Terms used in this present invention select currently and extensively used general terms as far as possible in consideration of functions of the present invention, but differ according to the intents or customs of those skilled in the art or the advent of new technologies. Additionally, in certain cases, there are terms that are arbitrarily selected by the applicant, and in this case, their meaning will be listed in detail in the corresponding description part of the present invention. Accordingly, terms used in the present invention should be defined on the basis of the meanings that the terms have and the contents throughout the present invention.

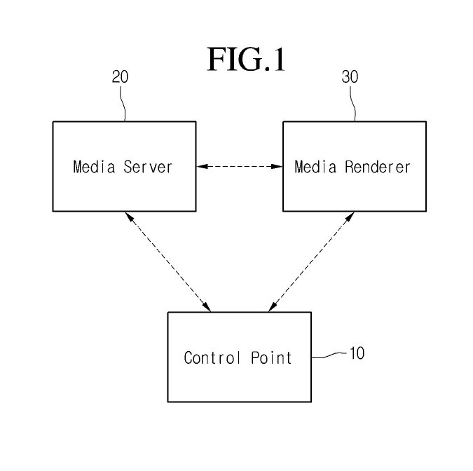

FIG. 1 is a block diagram illustrating a configuration of an UPnP network according to an embodiment of the present invention.

Universal Plug and Play (UPnP) is a technique that allows networking, especially, home networking, between network devices such as various electronic products, network printers, internet gates by extending internet standard technologies such as TCP/IP, HTTP, and XML to the entire network.

The UPnP network basically may include a plurality of UPnP devices, service, and a control point (CP).

The service means the smallest controller on a network and models a service itself through a state variable.

The CP means a control device having a function that monitors and controls other devices, and accordingly, a user discovers various devices through an interface that the CP provides to find out description and controls them.

Referring to FIG. 1, an UPnP network according to an embodiment of the present invention may include a media server 20 providing media data to a home network, a media renderer 30 playing media data through a home network, and a CP 10 controlling the media server 20 and the media renderer 30.

The CP 10 may obtain a state of the media server 20 and the media renderer 30 through an event.

In more detail, AVTransport and Rendering Control put a changed state variable into a state variable called LastChang, and after a predetermined time, notify it to the CP 10, and thus play a role to notify a state of a current device.

Additionally, the media server 20 notifies information on content each time there is an UPnP action, and then transmits content between the media server 20 and the media renderer 300 to play corresponding content through a streaming method.

The content streaming may be performed through various streaming methods, and an UPnP AV standard uses an Out-of-Band transfer protocol for the content streaming without regulating a streaming method additionally.

For example, when RTP is used for content transmission, a transmission state of media data may be monitored using RTCP, and based on this, a transmission parameter may be adjusted.

When the UPnP AV mechanism is further described, the CP 10 may control the media server 20 and the media renderer 30 by calling an UPnP action provided based on a standardized Simple Object Access Protocol (SOAP).

Additionally, the CP 10 joins an event service that an UPnP device provides to receive a state information change of a device.

The media server 20 may provide a ContentDirectory service providing a service for discovering media data that a server manages, a ConnectionManager service managing connection for streaming between the media server 20 and the media renderer 30, and an AVTransport service providing control such as play and stop for media.

Additionally, the media renderer 30 may provide a RenderingControl service controlling the brightness and contrast of a screen, a ConnectionManager service, and an AVTransport service 133.

Accordingly, the CP 10 obtains media file information of a server through the ContentDirectory service for the discovered media server 20 and media renderer 30, and based on this, provides a connection for content transmission between the media server 20 and the media renderer 30 through the ConnectionManger service, and plays corresponding content through the AVTransport service.

The CP 10 monitors information on a change in the content of the media server 20 or a state change of current content stream by joining an event that each service provides.

Moreover, devices configuring the UPnP network include UPnP middleware, and the UPnP middleware may support a networking function including Addressing, Discovery, Description, Control, Eventing, and presentation processes.

In the Addressing process, when UPnP devices access an UPnP network first time, they search a Dynamic Host Configuration Protocol (DHCP) server to receive an allocated Internet Protocol (IP) address and port from the server, or when the DHCP server does not operate, they automatically select and obtain an IP address and port within a predetermined range through an automatic IP designation function (Auto IP).

In this case, different UPnP devices obtain different IP addresses and ports through the Addressing process, and UPnP devices configuring one Single Board Computer (SBC) obtain the same IP address through the Addressing process, but obtain different ports.

As mentioned above, the UPnP devices using an IP address and port allocated by the DHCP server or selected by the Auto IP communicate with other devices on a network through a Transmission Control Protocol (TCP)/IP, and discovery and check other devices on a network by using an IP address.

The discovery process includes an advertising process in which an UPnP device (for example, the media server 20 or the media renderer 30) accesses an UPnP network first time and notifies itself to other devices operating on the UPnP network and a discovery process in which a control device (for example, the CP 10) accesses an UPnP network first time and searches for UPnP devices operating on the UPnP network.

In the advertising process, the UPnP devices accessing the UPnP network first time and obtaining a predetermined IP address and port through the addressing process may notify its access to devices that are connected to the network already by multicasting an advertising message that advertises itself.

Then, the CP 10 receiving the advertising message may register the IP address and port of a corresponding UPnP device as a control target.

Furthermore, in the discovery process, a control device accessing the UPnP network first time, i.e., the CP 10, may obtain a predetermined IP address and port through the addressing process, and multicast a searching message by using a Simple Service Discovery Protocol (SSDP) to discover UPnP devices operating on the network.

Accordingly, the UPnP devices receiving the searching message unicast a responses message to the CP 10, and the CP registers the IP address and port of the UPnP device unicasting the response message.

In the description process, the CP 10 requests a device specification file (for example, a service description XML file or a device description XML file) to an UPnP device and receives it through the IP address registered in the advertising process, in order to recognize a service that the UPnP device provides.

Moreover, in the control process, the CP 10 analyzes the device specification file obtained through the description process and recognizes a service that the UPnP device provides, and then, transmits a control command message for requesting the execution of a service that a corresponding device provides, and receives a response message according thereto to control the UPnP device.

Here, the control command message and the control response message, as control related data, may be expressed in XML by using a Simple Object Access Protocol (SOAP).

The eventing process checks whether an event occurs in the UPnP device that provides a predetermined service in response to a control command message delivered from the CP 10, for example, whether there is a state change.

In this case, in order to check a state change of the UPnP device, when the CP 10 transmits a message requesting a subdescription to a corresponding device, the corresponding device may transmit an event message in a text form to the CP by using General Event Notification Architecture (GENA) for notifying a state change.

Moreover, in the presentation process, the CP 10 reads an HTML page of the UPnP device, and the HTML page provides a user interface to control a device and displays a state of a controlled device.

Moreover, the CP 10, the media server 20, and the media renderer 30 may transmit/receive data through an IP based interface such as “Ethernet”, “USB”, “802.11”, “HSDPA”, “HomePNA”, “HomePlug”, “MoCA”, “G.hn” or “UPA”, and accordingly, although omitted in FIG. 1, an access point (AP) or a repeater may be further included for the IP based interface.

The configuration of the UPnP network described with reference to FIG. 1 is just one embodiment of the present invention, but the present invention is not limited thereto.

According to an embodiment of the present invention, UPnP devices, for example, the media server 20 and the media renderer 30, may be connected to each other by using a High Definition Multimedia Interface (HDMI).

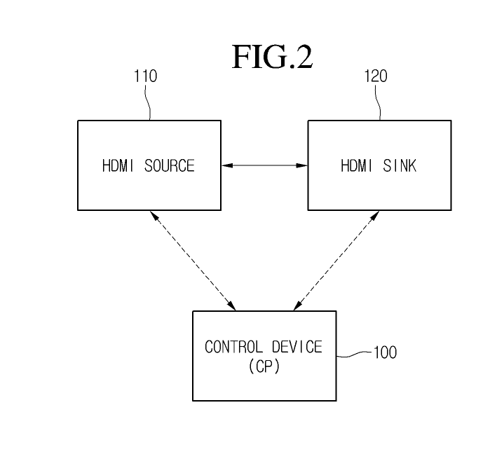

FIG. 2 is a block diagram illustrating a configuration of a content transmitting/receiving system according to an embodiment of the present invention. The shown content transmitting/receiving system may include a source device and a sink device connected through an HDMI. In block diagrams below, data transmission using an HDMI is indicated with a solid line, and data transmission through an IP based interface is indicated with a solid line.

A High Definition Multimedia Interface (HDMI) is a standard to transmit/receive high resolution image and sound through a digital interface, which is based on Digital Video Interactive (DVI) that is a standard for connecting a PC to a monitor.

Such an HDMI includes three independent channels such as Transition Minimized Differential Signaling (TMDS), Display Data Channel (DDC), and Consumer Electronics Control (CEC) as one physical cable, and through this, AV data, device information, and control commands are transmitted and received.

Referring to FIG. 2, an HDMI source 110, i.e., a source device, is a device that transmits/receives AV data through an HDMI cable, and an HDMI sink 120, i.e., a sink device, is a device that is positioned at the uppermost of a link receiving AV data among devices connected through an HDMI cable.

Moreover, in order to perform HDMI CEC communication, all devices need to have a valid CEC address, i.e., a physical address and a logical address.

The logical address is allocated by ping neighbor devices, and the physical address may be allocated by performing HDMI Hot Plug Detection (HDMI HPD).

For example, a TV system, i.e., a root device, has a physical address of ‘0.0.0.0’, and the other source devices may read and obtain a physical address from Extended Display Identification Data (EDID) ROM of a sink device through Display Data Channel (DDC) communication. The DDC communication is performed only when a +5V power signal applied by a source device is fed back from a sink device and is applied to an HPD line.

That is, when the HDMI source 110 receives an HPD signal from the HDMI sink 120, it recognizes the HDMI connection with the HDMI sink 110 and reads EDID information of the HDMI sink 120 to receive an allocated physical address by using the EDID information.

Moreover, the HDMI source 110 may receive an allocated physical address by performing a logical address discovery defined by the HDMI CEC standard.

The control device 100, as a device performing a function of a CP described with reference to FIG. 1, may detect and control the HDMI source 110 and the HDMI sink 120.

That is, in response to a control of the control device 100, the HDMI source 110 and the HDMI sink 120 may transmit/receive content through an IP based interface such as “Ethernet”, “USB”, “802.11”, “HSDPA”, “HomePNA”, “HomePlug”, “MoCA”, “G.hn” or “UPA”, or may transmit/receive content through an HDMI.

Here, a device having content is defined as an UPnP media server (MS) or a DLNA Digital Media Server (DMS). An HDMI source 110 having an HDMI output is defined as an UPnP media renderer (MR) or a DLNA Digital Media Renderer (DMR). In more detail, the HDMI source 110 may be defined as an UPnP “Decoding” media renderer (MR) or a DLNA “Decoding” DMR. The HDMI sink 120 having HDMI input may be defined as an UPnP media renderer (MR) [symbol] DLNA DMR. In more detail, the HDMI sink 120 may be defined as an UPnP “Displaying” media renderer (MR) or a DLNA “Displaying” DMR.

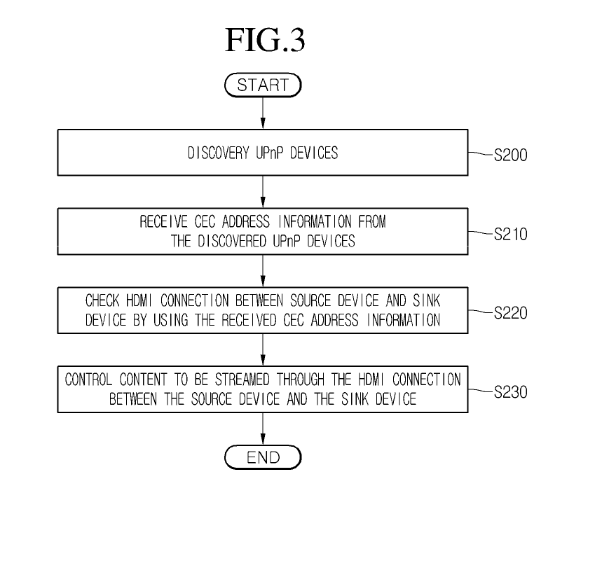

FIG. 3 is a flowchart illustrating a method of controlling content transmission according to an embodiment of the present invention. The shown control method is described with the block diagram of FIG. 2.

Referring to FIG. 3, the control device 100 discoveries a plurality of UPnP devices in operation S200, and receives CEC address information from the plurality of discovered UPnP devices.

For example, the HDMI source 110 and the HDMI sink 120 accessing an UPnP/DLNA network may be automatically discovered by the control device 100 according to the discovery process described with reference to FIG. 1.

Moreover, the discovered devices may be connected to each other or distinguished from each other by using an IP address and Universally Unique ID (UUID), and accordingly, the control device 100 may recognize a network map and topology according to the IP based interface by using the IP address and the UUID.

Additionally, the HDMI source 110 and the HDMI sink 120 connected through an HDMI may be automatically discovered as described with reference to FIG. 2, so that a CEC address, that is, a physical address and a logical address, may be allocated.

In operation S210, the control device 100 may transmit an UPnP message requesting the transmission of CEC address information to all UPnP devices discovered through an UPnP discovery protocol through an IP address of each device.

Accordingly, the control device 100 may receive CEC address information from the HDMI source 110 and the HDMI sink 120, and the CEC address information may include a CEC address of a corresponding device and a CEC address of a device connected to a corresponding device through an HDMI.

Then, the control device 100 checks an HDMI connection between a source device and a sink device by using the received CEC addresses in operation S220, and controls content to be streamed through the HDMI connection between the source device and the sink device in operation S230.

For example, the control device 100 may check which devices among the discovered UPnP devices are connected to each other through an HDMI by using the CEC address information received in operation S210, i.e., the CEC address for each of the discovered UPnP devices and the CEC address of a device connected thereto, and accordingly, may recognize that the HDMI source 110 and the HDMI sink 120 are connected to each other through an HDMI.

In operation S230, the control device 100 manages the HDMI connection between the HDMI source 110 and the HDMI sink 120, and controls content streaming through the HDMI connection. In addition to that, the control device 100 relays the content streaming to be delivered through another device.

Moreover, according to an embodiment of the present invention, as mentioned above, the control device 100 requests CEC address information to the discovered devices and receives it, but the present invention is not limited thereto. For example, in the UPnP discovery process described with reference to FIG. 1, each device may deliver its CEC address and a CEC address of a device connected thereto to the control device 100.

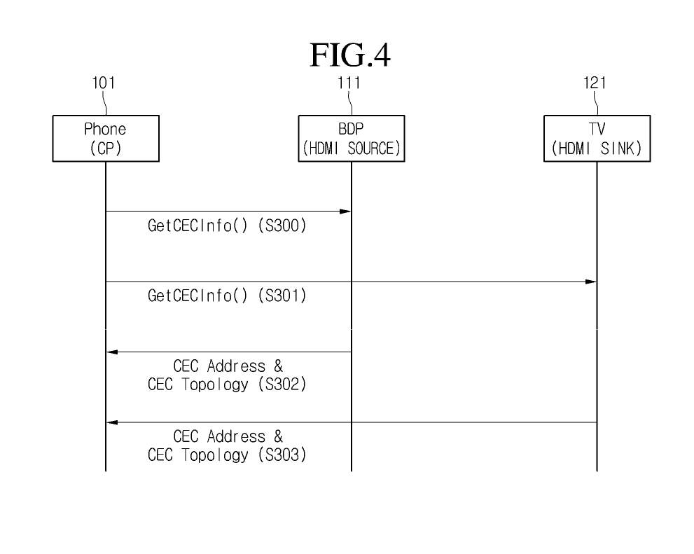

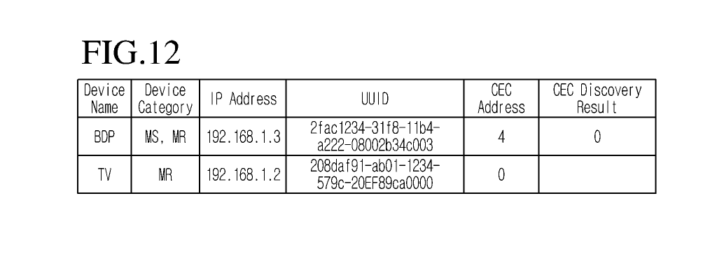

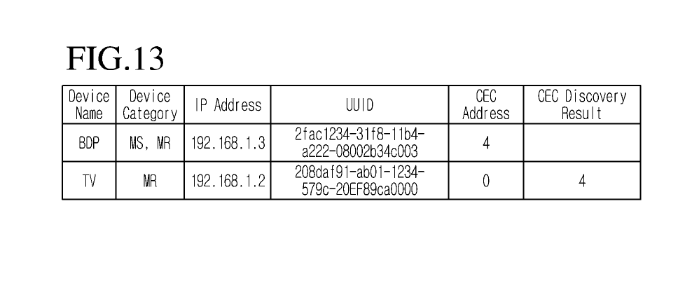

Hereinafter, referring to FIGS. 4 to 13, the method of the control device 100 to receive CEC address information of discovered UPnP devices in operation S210 will be described in more detail.

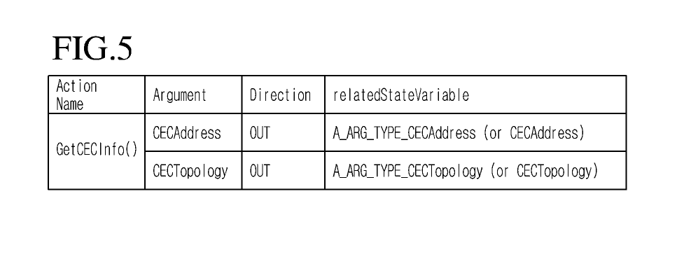

Referring to FIGS. 4 and 5, the control device 100 may newly define a GetCECInfo( ) action and a state variable relating thereto in order to request CEC address information to the devices discovered by the UPnP discovery protocol.

The control device 100 calls the GetCECInfo( ) action to receive whether a corresponding device supports an HDMI protocol with respect to each of the discovered UPnP devices, a CEC address of a corresponding device obtained by a CEC discovery protocol, and CEC topology information representing a CEC address of a device connected thereto through an HDMI.

In more detail, a state variable of the GetCECInfo( ) action may include CECAddress and CECTopology. The CECAddress indicates the CEC address of a discovered device, and the CECTopology indicates the CEC address of a device connected to a corresponding device through an HDMI.

When the control device 100 calls the GetCECInfo( ) action, discovered UPnP devices may report the CECAddress and CECTopology state variable values as output arguments of the action.

For example, when a Phone 101, i.e., a CP, calls the GetCECInfo( ) in operations S300 and S301, a Blu-ray Disk Player (BDP) 111 and a TV 121, i.e., UPnP devices connected through an HDMI, handover the CECAddress and CECTopology state variable values to report its CEC address and a CEC address (that is, CEC topology information) of a device connected thereto to the Phone 101 in operations 302 and 303.

The Phone 101, i.e., a CP, may check the CEC addresses and CEC topology of the BDP 111, i.e., an HDMI source, and the TV 121 of an HDMI sink, and accordingly, it is recognized that the BDP 111 and the TV 121 are connected to each other through an HDMI.

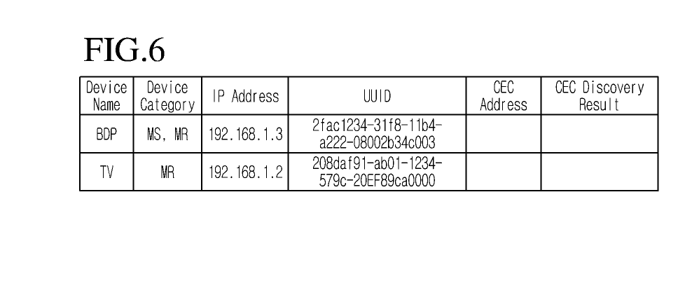

FIGS. 6 to 13 are views illustrating device discovery result information obtained by the control device 100 through the discovery processes and CEC address information request process. The discovery result information may include a device category for each of discovered UPnP devices, an IP address, a UUID, a CEC address, and a CEC discovery result (i.e., CEC topology information).

Referring to FIG. 6, when the BDP 111 and the TV 121 do not support an HDMI/CEC protocol, the CEC address and CEC topology information of the BDP 111 and the TV 121 are not handed over to the Phone 101 as a state variable to the GetCECInfo( ).

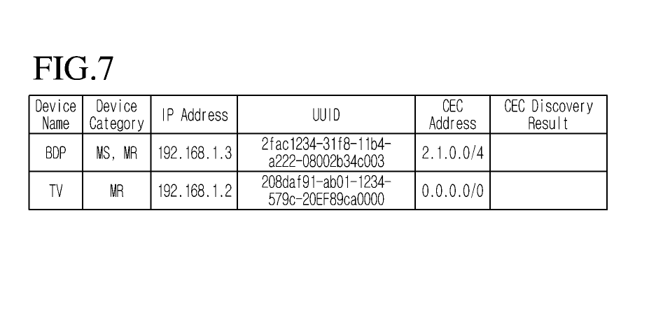

Referring to FIG. 7, when the BDP 111 and the TV 121 support an HDMI/CEC protocol but are not connected to each other, the CEC addresses of the BDP 111 and the TV 121 are handed over to the Phone 101 as a state variable to the GetCECInfo( ) but CEC topology information is not reported.

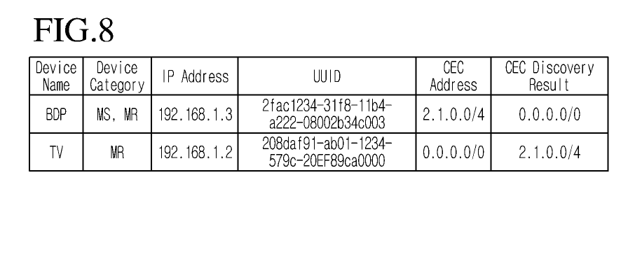

Referring to FIG. 8, when the BDP 111 and the TV 121 support an HDMI/CEC protocol and are connected to each other, the CEC addresses and CEC topology information of the BDP 111 and the TV 121 are handed over to the Phone 101 as a state variable to the GetCECInfo( ).

In this case, as the CEC topology information of the BDP 111 represents “0.0.0.0/0”, i.e., the CEC address of the TV 121 and the CEC topology information of the TV 121 represents “2.1.0.0/4”, i.e., the CEC address of the BDP 111, the Phone 101, i.e., a CP, may recognize that the BDP 111 and the TV 121 are connected to each other through an HDMI.

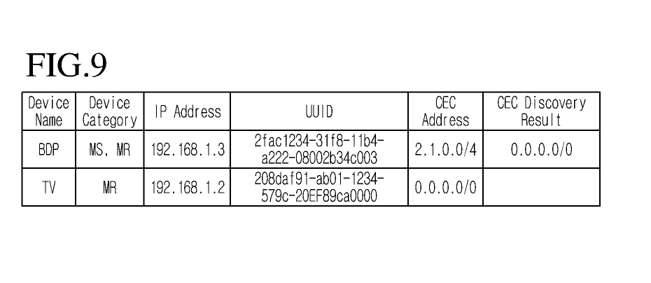

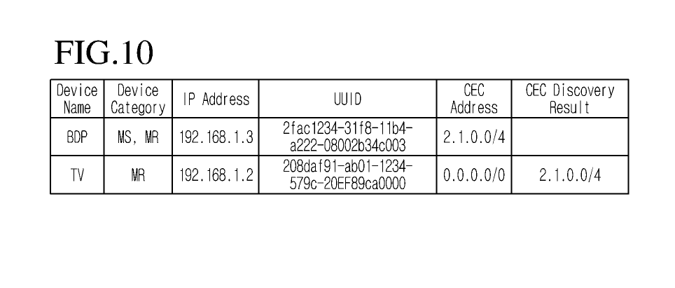

Moreover, referring to FIGS. 9 and 10, only one of an HDMI source and an HDMI sink may hand over the CEC topology information to the control device 100 as a state variable to the GetCECInfo( ) action.

For example, as shown in FIG. 9, only the BDP 111, i.e., an HDMI source, may report the CEC topology information to the Phone 101, i.e., a CP, or as shown in FIG. 10, only the TV 111, i.e., an HDMI sink (or, a root or an MR) may report the CEC topology information to the Phone 101.

In this case, the Phone 101, i.e. a CP, may sufficiently recognize that the BDP 111 and the TV 121 are connected to each other through an HDMI/CEC protocol only with one CEC topology information.

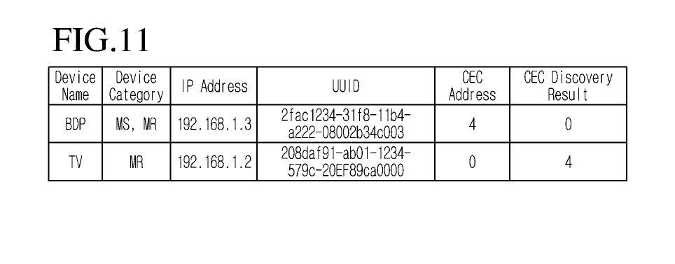

Additionally, referring to FIGS. 11 to 13, devices are distinguished from each other only with the logical address in the CEC address, so that CEC address information, i.e., a CEC address and CEC topology, may include only a logical address.

Moreover, the DLNA defines a 2-box model and a 3-box model.

The 2-box model includes a DMP and a DMS. In the 2-box model, the DMP allows a user to find and play a content advertized and distributed by the DMS.

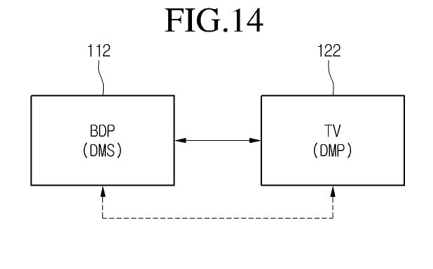

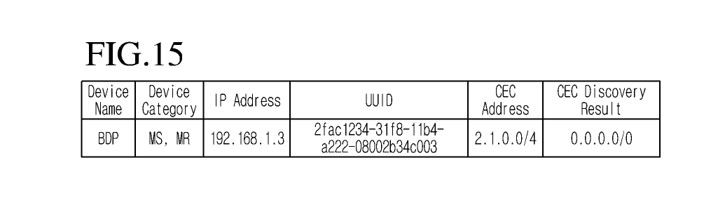

Referring to FIGS. 14 and 15, when the BDP 112, i.e., a DMS, and the TV 122, i.e., a DMP, are connected to each other through an HDMI, the TV 122 may obtain information such as the IP address, UUID, CEC address, and CEC topology of the BDP 112 through the discovery process.

Moreover, the TV 122 confirms that the CEC topology information of the BDP 122 includes “0.0.0.0/0”, i.e., the CEC address of the TV 122, so that the TV 122 can recognize that the TV 122 is connected by using an HDMI/CEC protocol to the BDP 112 to which a CEC address of “2.1.0.0/4” is allocated.

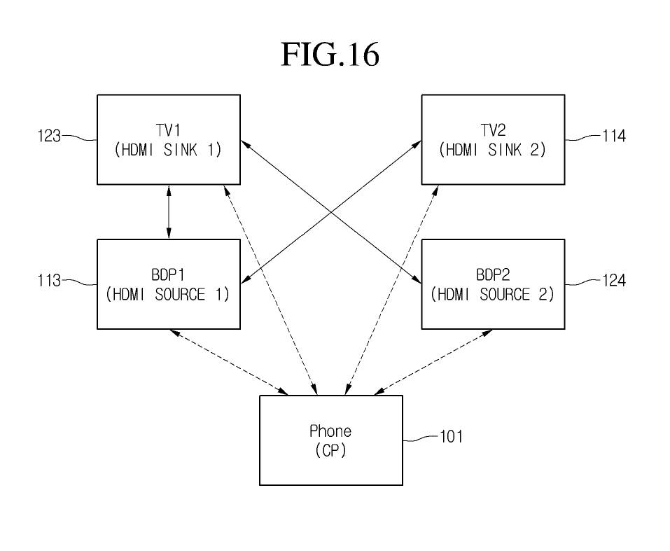

FIG. 16 is a block diagram illustrating a configuration of a content transmitting/receiving system according to another embodiment of the present invention. The shown network may include a plurality of source devices and sink devices connected through an HDMI.

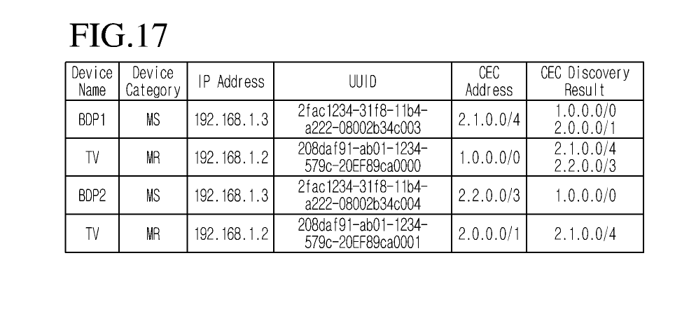

In this case, the Phone 101, i.e., a CP, may obtain an IP address, UUID, a CEC address, and CEC topology information as shown in FIG. 17 with respect to each of a BDP1 113, TV1 123, BDP2 114, and a TVV2, i.e., a plurality of devices configuring a network, through the discovery process.

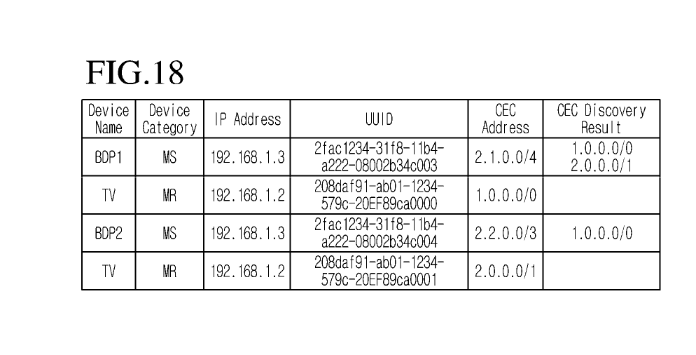

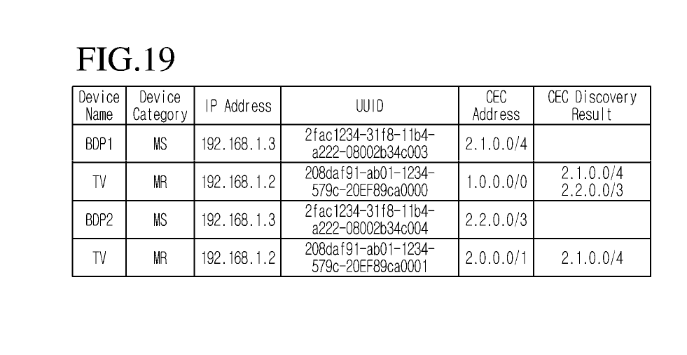

Moreover, referring to FIGS. 18 and 19, one of an HDMI source and an HDMI sink, for example, only the BDP1 113 and BDP 114 or the TV1 123 and TV2 124, may report the CEC topology information to the Phone 101, i.e., a CP.

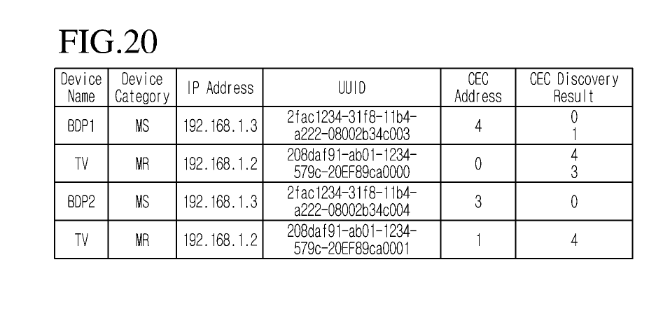

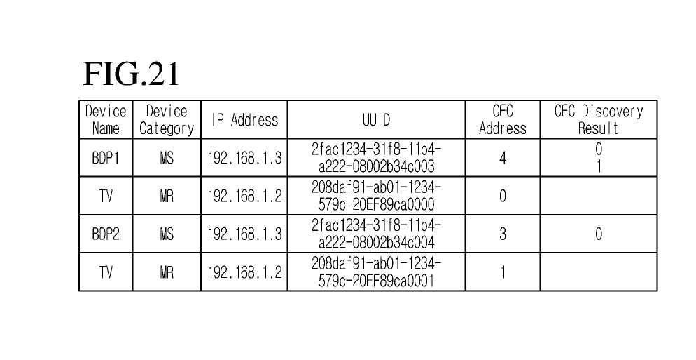

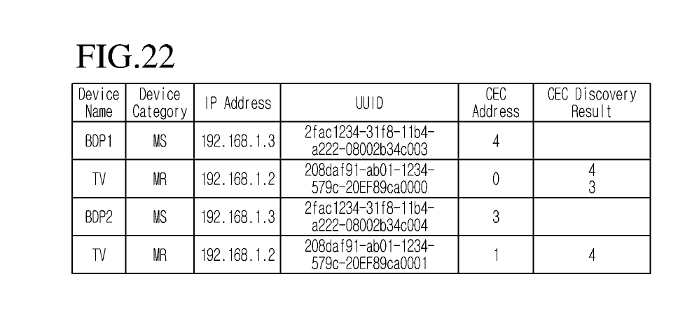

Additionally, as shown in FIGS. 20 to 22, the CEC address and the CEC topology for each of the plurality of discovered devices may include only a logical address allocated to a corresponding device.

According to another embodiment of the present invention, the control device 100 may request CEC address information on the searched UPnP devices by using an existing action defined in the UPnP.

For example, the control device 100 may request CEC address information on UPnP devices by using Browse/Search( ) or GetProtocolInfo( ) which are actions defined in the ContentDirectory service and the ConnectionManager service of the UPnP.

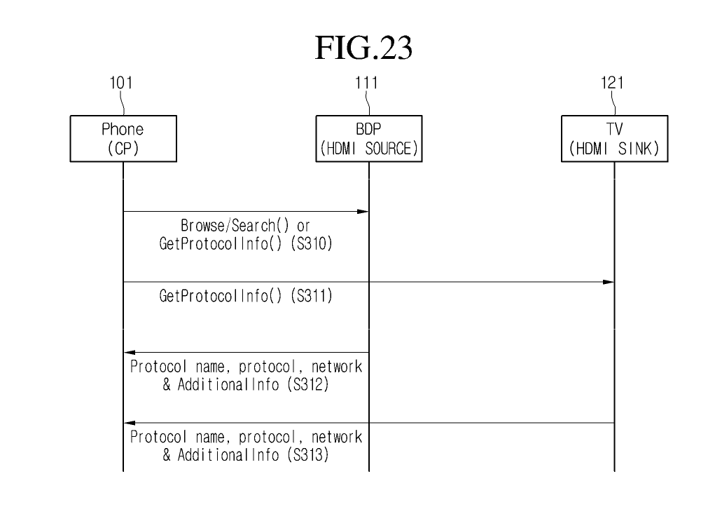

FIG. 23 is a ladder diagram illustrating a method of receiving CEC address information of UPnP devices according to a second embodiment of the present invention.

Referring to FIG. 23, the Phone 101, i.e., a CP, calls a Browse/Search( ) or GetProtocolInfo( ) action in operations S310 and S311, and then receives a protocol name, a protocol, and network and additional information AdditionalInfo from the BDP 111 and the TV 121 in response to a corresponding action in operations S312 and S313.

In more detail, with respect to the BDP 111, i.e., an MS, the Phone 101, i.e., a CP, calls the Browse/Search( ) action to obtain res@procotolInfo as a CDS property, or calls the GetProtocolInfo( ) action to receive SourceProtocolInfo as an output independent variable and SinkProtocolInfo state variable values.

With respect to the TV 112, i.e., an MR, the Phone 101, i.e., a CP, calls the GetProtocolInfo( ) action to receive SourceProtocolInfo as an output independent variable and SinkProtocolInfo SinkProtocolInfo state variable values.

Moreover, by using the Browse/Search( ) or GetProtocolInfo( ) action to receive CEC address information, it is necessary to add an HDMI protocol to the definition for ProtocolInfo and its values.

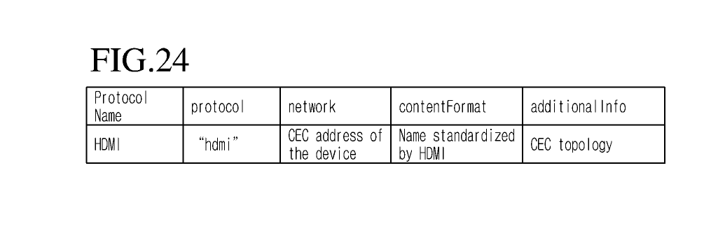

Referring to FIG. 24, in relation to the ProtocolInfo and its values including the added HDMI protocol, a protocol name is “HDMI”, a protocol is “hdmi”, a network includes the CEC address of a corresponding device, contentFormat includes name standardized in an HDMI, and additionalInfo includes CEC topology information.

Moreover, the contentFormat exists only for an MS, and when the MS is capable of decoding a content to be played in an uncompressed file format defined in the HDMI, a corresponding field may be filled.

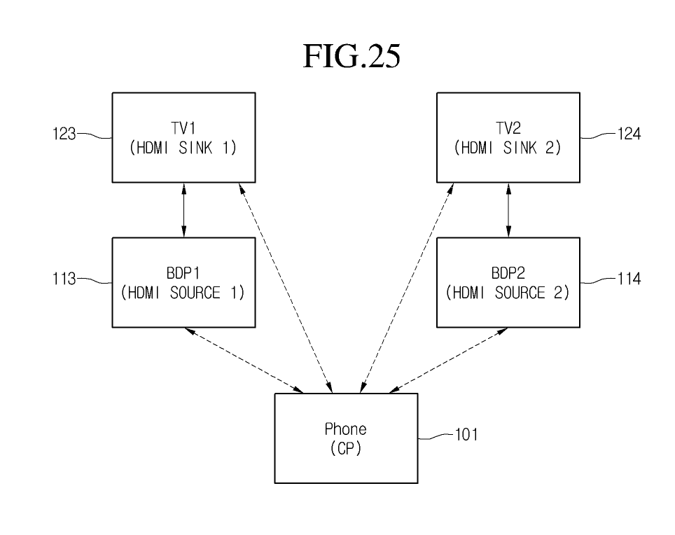

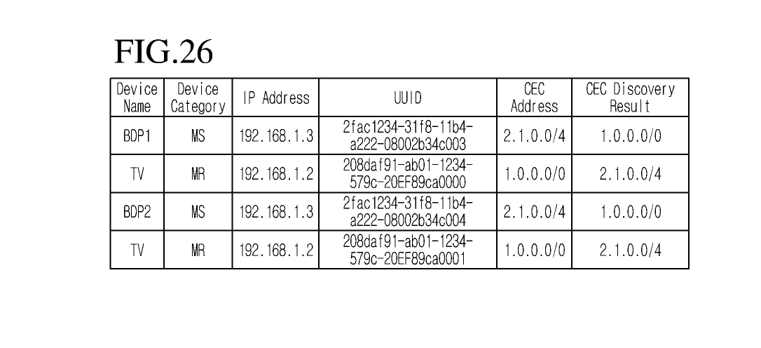

FIGS. 25 and 26 are views illustrating a method of validating an HDMI connection between a source device and a sink device according to an embodiment of the present invention. That is, the method of validating an HDMI connection in operation S220 of FIG. 3 is described in more detail.

Referring to FIG. 25, a BDP1 113, a TV1 123, a BDP2 114, and a TV2 124 are connected to each other through an HDMI, so that each independent HDMI network may be configured.

Moreover, as shown in FIG. 26, the BDP1 113 and the BDP2 114 may have the same CEC address and the TV1 123 and TV2 124 may have the same CEC address. In this case, the phone 101, i.e., a CP, may recognize that the BDP1 113 and the TV2 124, and the BDP2 114 and the TV 123, which are not actually connected to each other, are connected to each other through an HDMI.

In order to prevent such a determination error, the Phone 101, i.e., a CP, may perform a process for validating the recognized HDMI connection again by using CEC address information.

As one embodiment, the control device 100 transmits a connection validation request message to one of an HDMI source and an HDMI sink, which are recognized being connected to each other, through CEC address information, and when there is a response to the connection validation request message from the one, it is validated that the two devices are connected to each other through an HDMI.

For example, when the Phone 101 transmits a connection validation request message to the BDP1 113, a corresponding message is delivered to the TV1 123 through an HDMI cable, and by receiving a response to the connection validation request message from the TV1 123, the Phone 101 may validate that the BDP1 is connected to the TV1 123 through an HDMI and is not connected to the TV2 124.

After validating an HDMI connection between UPnP devices through the above method, the control device 100 may manage an HDMI connection by turning on/off an HDMI session between the HDMI source 110 and the HDMI sink 120.

For example, the control device 100, i.e., a CP, transmits to at least one of the HDMI source 110 and the HDMI sink 120 an UPnP control message for turning on or off an HDMI session between the HDMI source 110 and the HDMI sink 120, and then controls a CEC message corresponding to the transmitted UPnP control message to be transmitted/received through the HDMI connection between the HDMI source 110 and the HDMI sink 120, so that the HDMI connection may be managed.

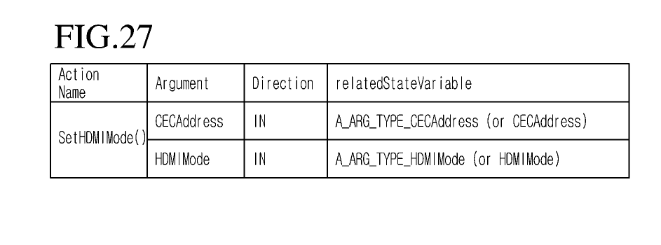

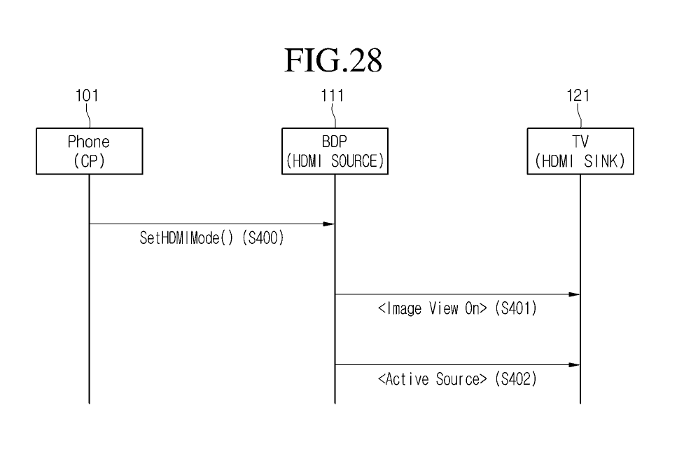

FIGS. 27 and 28 are views illustrating a method of turning on an HDMI session between a source device and a sink device according to a first embodiment of the present invention.

Referring to FIG. 27, a SetHDMIMode action and state variables relating thereto may be newly defined as an UPnP control message allowing the control device 100 to turn on an HDMI session between the HDMI source 110 and the HDMI sink 120.

The control device 100 may make a request to turn on an HDMI session between the HDMI source 110 and the HDMI sink 120 by calling the SetHDMIMode( ) action.

In more detail, a state variable of the SetHDMIMode( ) action may include CECAddress and HDMIMode. The CECAddress indicates the CEC address of an HDMI input device, and the HDMIMode indicates whether the HDMI session is turned on/off.

When the control device 100 calls the SetHDMIMode( ) action, the CECAddress and HDMIMode state variable values may be included as input arguments of the action.

Moreover, among the HDMI source 110 and the HDMI sink 120, one receiving the calling of the SetHDMIMode( ) action may convert a corresponding UPnP control message into a CEC message for turning on/off the HDMI session (for example, <Active Source> [symbol] <Image View On>), and then transmits the converted CEC message to another device.

The above SetHDMIMode( ) action and its state variable values are used for CEC message exchange between the HDMI source 110 and the HDMI sink 120, and the HDMI session may be turned on/off between the HDMI source 110 and the HDMI sink 120 through the CEC message exchange.

Referring to FIG. 28, the Phone 101, i.e., a CP, calls the SetHDMIMode( ) action from the BDP 111, i.e., an HDMI source, in operation S400, and the called SetHDMIMode( ) action may include the CEC address of the TV 121, i.e., an HDMI sink and a value for turning on an HDMI session (for example, ‘1’), which are input arguments, as the CECAddress and HDMIMode state variable values.

The BDP 111 receiving the calling of the SetHDMIMode( ) action validates the CECAddress and HDMIMode state variable values, and then sequentially transmits to the TV 121 <Image View On> and <Active Source>, i.e., CEC messages for turning on the HDMI session with the TV 121 in operations S401 and S402.

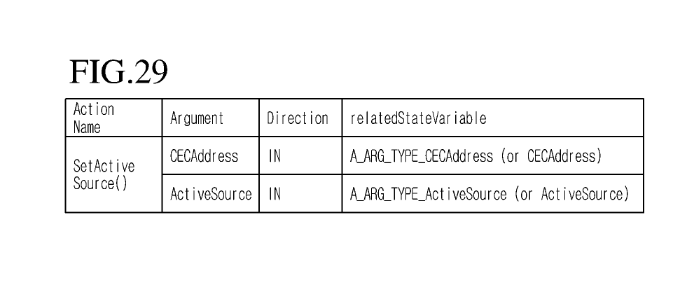

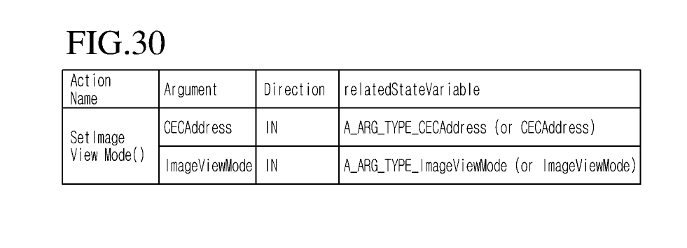

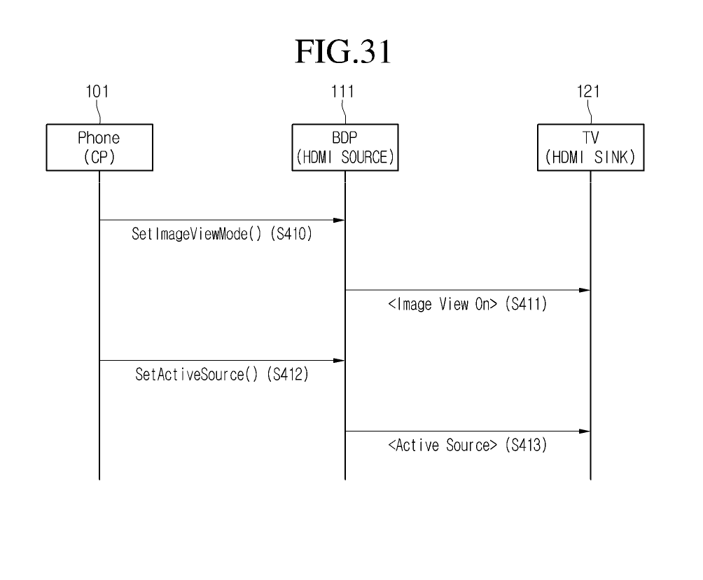

FIGS. 29 and 31 are views illustrating a method of turning on an HDMI session between a source device and a sink device according to a second embodiment of the present invention.

Referring to FIGS. 29 and 30, a SetActiveSource( ) action and state variables relating thereto and a SetImageViewMode( ) action and state variables relating thereto may be newly defined as an UPnP control message allowing the control device 100 to turn on an HDMI session between the HDMI source 110 and the HDMI sink 120.

The control device 100 may make a request to turn on an HDMI session between the HDMI source 110 and the HDMI sink 120 by sequentially calling the SetImageViewMode( ) action and the SetActiveSource( ) action.

In more detail, a state variable of the SetActiveSource( ) action may include CECAddress and ActiveSource. The CECAddress indicates the CEC address of an HDMI input device.

Additionally, the ActiveSource state variable has a value of “0” or “Inactive” string when a source is “not active”, and has a value of “1” or “Active” string when the source is “active”.

When the control device 100 calls the SetActiveSource( ) action, the CECAddress and ActiveSource state variable values may be included as input arguments of the action.

Moreover, among the HDMI source 110 and the HDMI sink 120, one receiving the calling of the SetActiveSource( ) action may convert a corresponding UPnP control message into <Active Source>, i.e., a CEC message, and then transmits the converted CEC message to another device.

Also, a state variable of the SetImageViewMode( ) action may include CECAddress and ImageViewMode. The CECAddress indicates the CEC address of an HDMI input device.

The ImageViewMode state variable has a value of “0” or “ImageViewModeOff” string when the Image View mode is “off”, and has a value of “1” or “ImageViewModeOn” string when a corresponding value is set to default and the Image View mode is “on”.

When the control device 100 calls the SetImageViewMode( ) action, the CECAddress and ImageViewMode state variable values may be included as input arguments of the action.

Moreover, among the HDMI source 110 and the HDMI sink 120, one receiving the calling of the SetImageViewMode( ) action may convert a corresponding UPnP control message into <Image View On>, i.e., a CEC message, and then transmits the converted CEC message to another device.

Referring to FIG. 31, the Phone 101, i.e., a CP, calls the SetImageViewMode( ) action from the BDP 111, i.e., an HDMI source, in operation S410, and the called SetImageViewMode( ) action may include the CEC address of the TV 121, i.e., an HDMI sink and a value representing that the Image View mode is “on” (for example, “1” or “ImageViewModeOn” string), which are input arguments, as the CECAddress and ImageViewMode state variable values.

The BDP 111 receiving the calling of the SetImageViewMode( ) action validates the CECAddress and ImageViewMode state variable values, and then transmits <Image View On>, i.e., a CEC message corresponding thereto, to the TV 411 in operation S411.

Then, the Phone 101, i.e., a CP, calls the SetActiveSource( ) action from the BDP 111, in operation S412, and the called SetActiveSource( ) action may include the CEC address of the TV 121, and a value representing “active” (for example, “1” or “Active” string), which are input arguments, as the CECAddress and ActiveSource state variable values.

The BDP 111 receiving the calling of the SetImageViewMode( ) action validates the CECAddress and ActiveSource state variable values, and then transmits <Active Source>, i.e., a CEC message corresponding thereto, to the TV 411 in operation S413.

As mentioned above, after an HDMI session between the HDMI source 110 and the HDMI sink 120 is turned on, the control device 100 may control content streaming from the HDMI source 110 to the HDMI sink 120 through an HDMI connection.

According to an embodiment of the present invention, the control device 100 may control content streaming from the HDMI source 110 to the HDMI sink 120 through an HDMI connection by using the AVTransport service defined in UPnP.

For example, the control device 100 may transmit to at least one of the HDMI source 110 and the HDMI sink 120 an UPnP control message for performing a control operation such as play, stop, and pause on a content to be streamed.

Moreover, among the HDMI source 110 and the HDMI sink 120, one receiving the UPnP control message from the control device 100 may convert the received UPnP control message into a CEC message, and then transmits a CEC message corresponding thereto to another device through an HDMI.

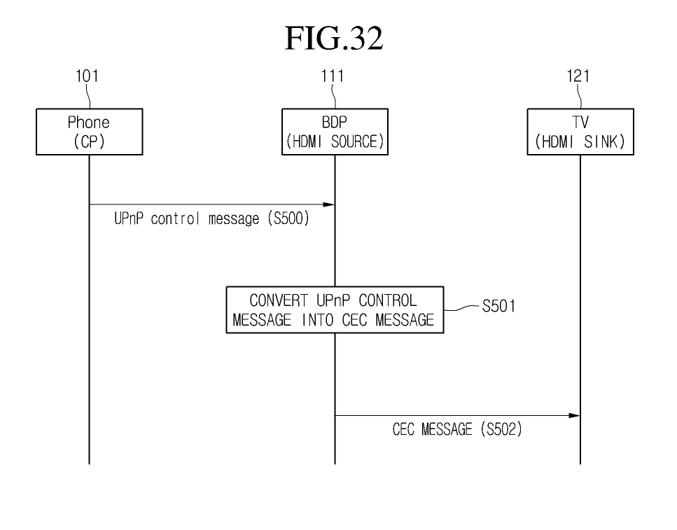

Referring to FIG. 32, when an AVT is realized in the BDP 111, i.e., an HDMI source, the Phone 101, i.e., a CP, transmits AVT actions for requesting an operation to be controlled to the BDP 111 to deliver an UPnP control message in operation S500.

Accordingly, the Phone 101 plays content in the BDP 111 by using the UPnP control protocol and controls the BDP 111.

Since AVT actions for controlling HDMI content streaming between the HDMI source 110 and the HDMI sink 120 are identical to those defined in the UPnP standard, their detailed descriptions are omitted.

After the BDP 111 converts the received UPnP control message into the CEC message in operation S501, it delivers the converted CEC message to the TV 121 through an HDMI connection in operation S502.

Accordingly, the BDP 111 may controls the HDMI content streaming toward the TV 121 by using the CEC protocol.

Since the CEC message converted to correspond to the UPnP control message is identical to the control message defined in the CEC protocol, its detailed description is omitted.

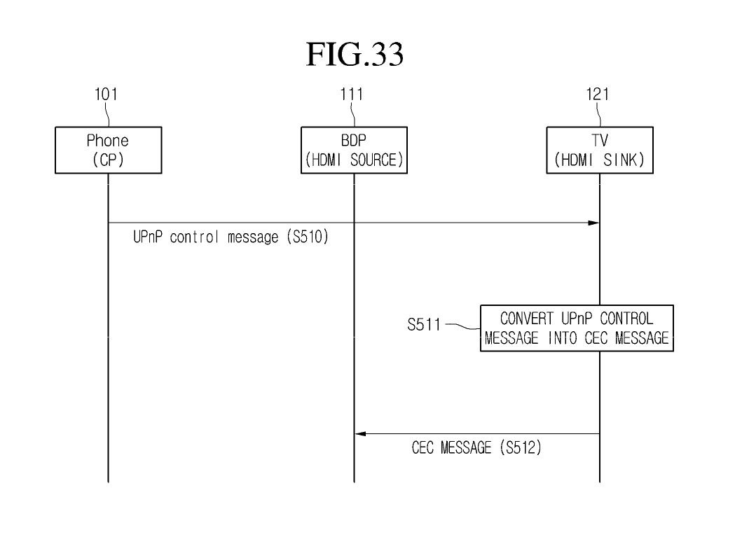

Referring to FIG. 33, when an AVT is realized in the TV 121, i.e., an HDMI sink, the Phone 101, i.e., a CP, transmits AVT actions for requesting an operation to be controlled to the TV 121 to deliver an UPnP control message in operation S510.

After the TV 121 converts the received UPnP control message into the CEC message in operation S511, it delivers the converted CEC message to the BDP 111 through an HDMI connection in operation S512.

Accordingly, the TV 121 may control the HDMI content streaming from the BDP 111 by using the CEC protocol.

According to another embodiment of the present invention, the control device 100 may perform a process for checking whether UPnP devices discovered using the UPnP discovery protocol can decode content to be streamed through an HDMI protocol.

For this, the control device 100 may request the transmission of information on a content format that a corresponding device can support to discovered devices, for example, the HDMI source 110 and the HDMI sink 120.

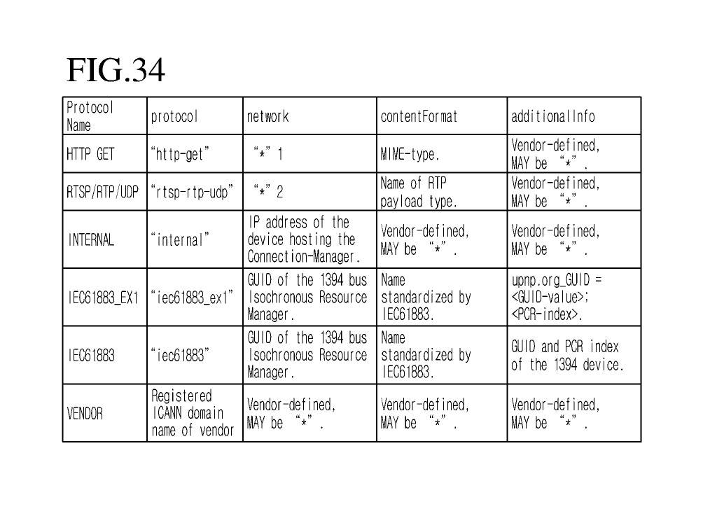

FIGS. 34 to 38 are views illustrating a method of checking whether UPnP devices can decode content according to embodiments of the present invention.

The control device 100 may obtain information on a supportable decoding format of an HDMI output device (for example, the HDMI source 110) by using a Browse/Search( ) action defined in the ContentDirectory service of UPnP or a GetProtocolInfo( ) action defined in the ConnectionManager service, and defined protocols and ProtocolInfo values relating thereto are identical to those of FIG. 34.

Referring to FIG. 34, in response to the Browse/Search( ) action or GetProtocolInfo( ) action that the control device 100 calls, a value designated in “contentFormat” among ProtocolInfo values received from the HDMI source 110 having an HDMI output may include information on a content format that a corresponding device can decodes.

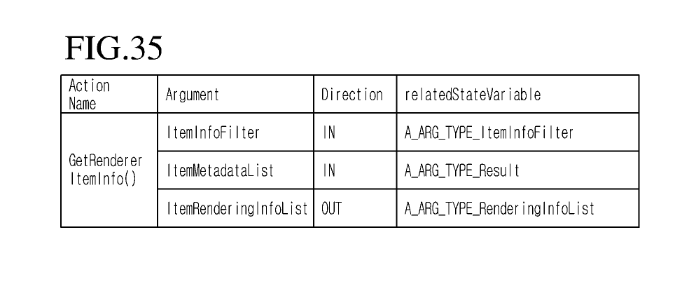

Referring to FIG. 35, the control device 100 may obtain information on a supportable decoding format of discovered devices by using the GetRendererItemInfo( ) action defined in the ConnectionManager service of UPnP.

In this case, the control device 100, i.e., a CP, requests provided inspect item metadata of a rendering device by calling the GetRendererItemInfo( ) so that the control device 100 can check whether a corresponding rendering device can play an item to be streamed successfully.

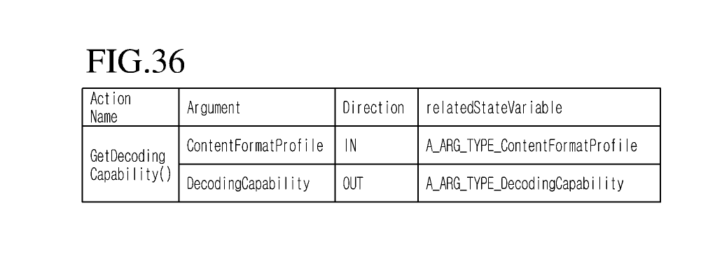

Referring to FIG. 36, a GetDecodingCapability( ) action and state variables relating thereto may be newly defined in order to check whether the control device 100 can decode a content transmitted through the HDMI protocol.

The control device 100 may obtain information on whether an HDMI output device can decode a content to be streamed by calling the GetDecodingCapability( ) action.

In more detail, the state variable of the GetDecodingCapability( ) action includes ContentFormatProfile and DecodingCapability. The ContentFormatProfile indicates a file format profile of a target content to be streamed through the HDMI protocol. The DecodingCapability indicates whether a corresponding device can decode a content including a file format profile designated in the ContentFormatProfile.

When the control device 100 calls the GetDecodingCapability( ) action including the ContentFormatProfile state variable value as an input argument, a device receiving the calling of the GetDecodingCapability( ) action hands over the DecodingCapability state variable value as an output argument of the action, so that the device may notify the control device 100 whether the device can decode a target content.

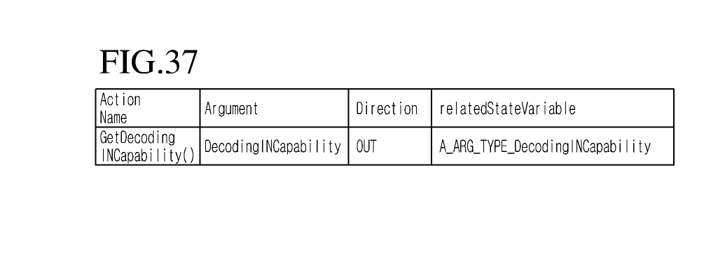

Referring to FIG. 37, a GetDecodingINCapability( ) action and state variables relating thereto may be newly defined, in order to check whether the control device 100 can decode a content transmitted through the HDMI protocol.

The control device 100 may call the GetDecodingINCapability( ) action to obtain information on whether an HDMI output device can decode a content to be streamed.

In more detail, the state variable of the GetDecodingINCapability( ) action includes DecodingINCapability. The DecodingINCapability indicates all input file formats that a corresponding device can decode.

When the control device 100 calls the GetDecodingINCapability( ) action, a device receiving the calling of the GetDecodingINCapability( ) action hands over the DecodingINCapability state variable value as an output argument of the action, so that the device may notify all decodable input file formats to the control device 100.

The control device 100 checks the DecodingINCapability state variable value, so that the control device 100 can check whether a corresponding HDMI output device can decode a target content to be streamed through the HDMI protocol.

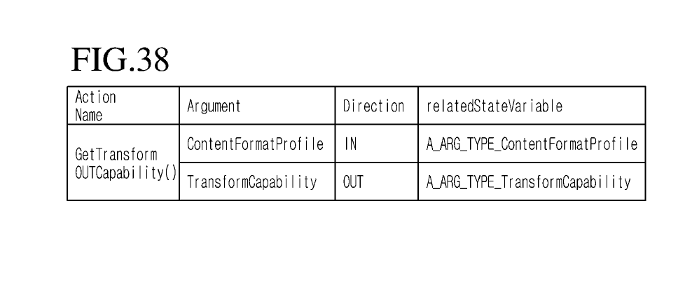

Referring to FIG. 38, a GetTranformOUTCapability( ) action and state variables relating thereto may be newly defined in order to check whether the control device 100 can decode a content transmitted through the HDMI protocol.

The control device 100 may obtain information on whether an HDMI output device can decode a content to be streamed by calling the GetTranformOUTCapability( ) action.

In more detail, the state variable of the GetTranformOUTCapability( ) action includes ContentFormatProfile and TransformCapability. The ContentFormatProfile indicates a file format profile of a target content to be streamed through the HDMI protocol. The TransformCapability indicates whether a corresponding device can convert a content having a file format profile designated in the ContentFormatProfile.

When the control device 100 calls the GetTranformOUTCapability( ) action including the ContentFormatProfile state variable value as an input argument, a device receiving the calling of the GetTranformOUTCapability( ) action hands over the TransformCapability state variable value as an output argument of the action, so that the device may notify the control device 100 whether the device can convert a target content.

Whether a content for the checked HDMI output device is decodable may be used for determining a transmission route of a content to be streamed, or determining the relay streaming of the content through another device.

According to another embodiment of the present invention, the control device 100 controls the HDMI source 110 to receive content from another MS, i.e., one of UPnP devices discovered by the UPnP discovery protocol, decode the received content, and stream the decoded content to the HDMI sink 120 through HDMI connection.

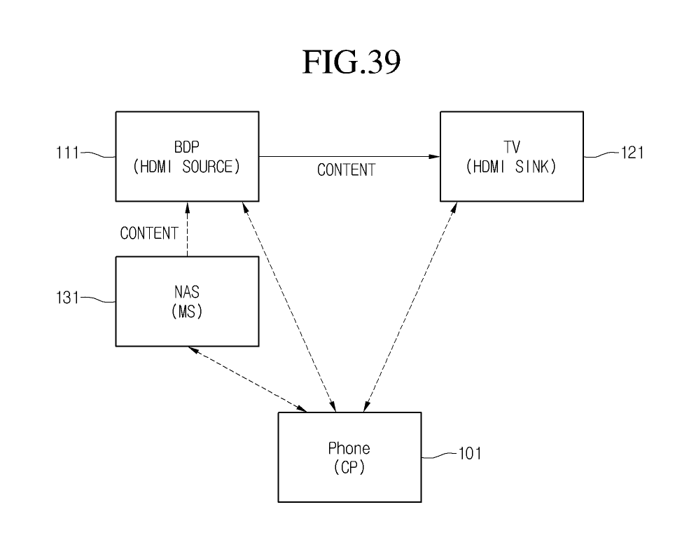

Referring to FIG. 39, when a content stored in a Network Attached Storage (NAS) 131, i.e., an MS, is to be played in the TV 121, the Phone 101, i.e., a CP, may check whether a corresponding content is decoded with respect to each of the NAS 131 and the BDP 111, i.e., an MS connected to the TV 121 through an HDMI by using the method described with reference to FIGS. 34 to 38.

When the NAS 131 cannot decode a corresponding content and the BDP 111 can decode a corresponding content on the basis of the check result, the Phone 101 controls the NAS 131 to transmit a stored content to the BDP 111 and also controls the BDP 111 to decode the received content and transmit it to the TV 121, so that relay streaming on content can be performed.

Moreover, as shown in FIG. 39, when the NAS 131 is not connected to the TV 121 through an HDMI, the Phone 101, i.e., a CP, may control devices to perform relay streaming through the BDP 111.

That is, when an MS having a selected content item is not connected to an MR through an HDMI or cannot decode a corresponding content item, a CP searches for a device for decoding the content among MSs connected to the MR through an HDMI and relays the content through the device to be streamed.

According to an embodiment of the present invention, the HDMI source 110 described with reference to FIGS. 2 to 39 includes an MS defined in UPnP and an MR. The HDMI sink 120 includes an MR.

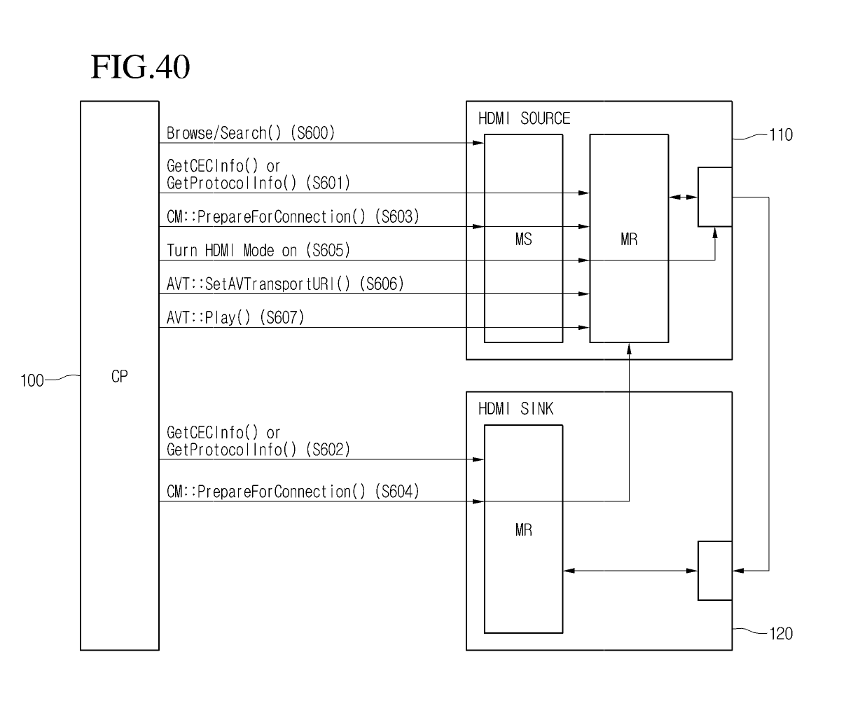

Referring to FIG. 40, the HDMI source 110 includes an MS and an MR. The HDMI sink 120 includes an MR.

After calling a Browse/Search( ) action from the MS of the HDMI source 110 in operation S600, the CP 100 obtains CEC address information on the HDMI source 110 and information on whether content can be decoded by calling a GETCECInfo( ) or GetProtocolInfo( ) action from the MR of the MDMI in operation S601, and also obtains CEC address information on the HDMI sink 120 and information on whether content can be decoded by calling the GETCECInfo( ) or GetProtocolInfo( ) action from the MR of the HDMI sink 120 in operation S602.

The CP 100 calls a PrepareForConnection( ) action from the MS and MR of the HDMI source 110 in operation S603, and calls a PrepareForConnection( ) action from the MR of the HDMI sink 120 in operation S604.

Then, the CP 100 transmits an UPnP control message for turning on an HDMI session between the HDMI source 110 and the HDMI 120 to the MR of the HDMI source 110 in order to turn on the HDMI mode in operation S605, and sequentially calls a SetAVTansportURI( ) action and a Play( ) action in operations S616 and S617.

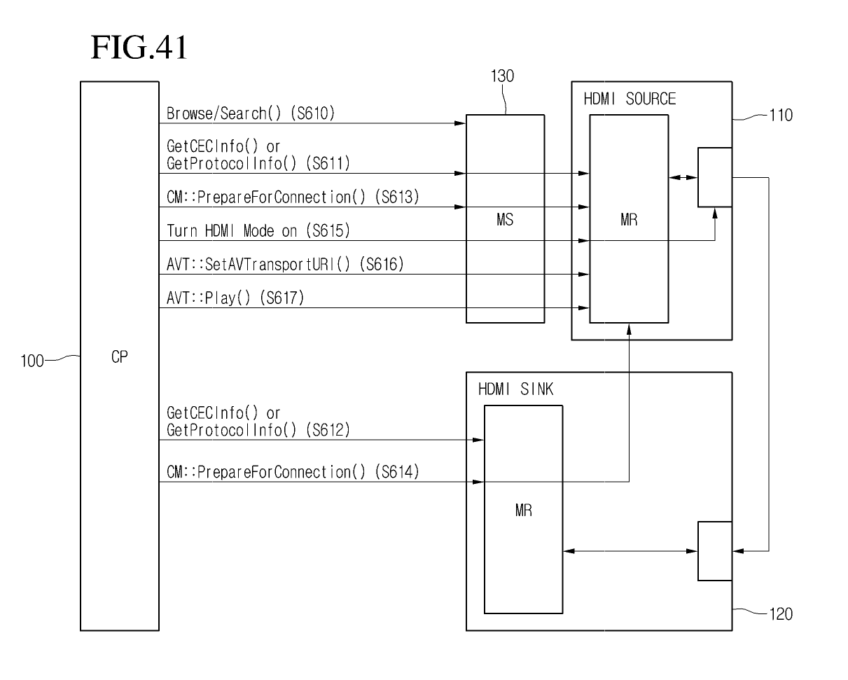

Referring to FIG. 41, when the HDMI source 110 relays the content that the MS 130 has to stream it to the HDMI sink 120 through HDMI connection, it may include the MR 110.

In this case, The CP 100 calls a Browse/Search( ) action from the MS 130 in operation S610, and then calls a GETCECInfo( ) or GetProtocolInfo( ) action from the MS 130, the MR of the HDMI source 110, and the MR of the HDMI sink 120 to obtain CEC address information and information on whether content decoding is available in operations S611 and S612.

The CP 100 calls a PrepareForConnection( ) action from the MS 130 and MR of the HDMI source 110 in operation S613, and calls a PrepareForConnection( ) action from the MR of the HDMI sink 120 in operation S614.

Then, the CP 100 transmits an UPnP control message for turning on an HDMI session between the HDMI source 110 and the HDMI 120 to the MR of the HDMI source 110 in order to turn on the HDMI mode in operation S615, and sequentially calls a SetAVTransportURI( ) action and a Play( ) action in operations S616 and S617.

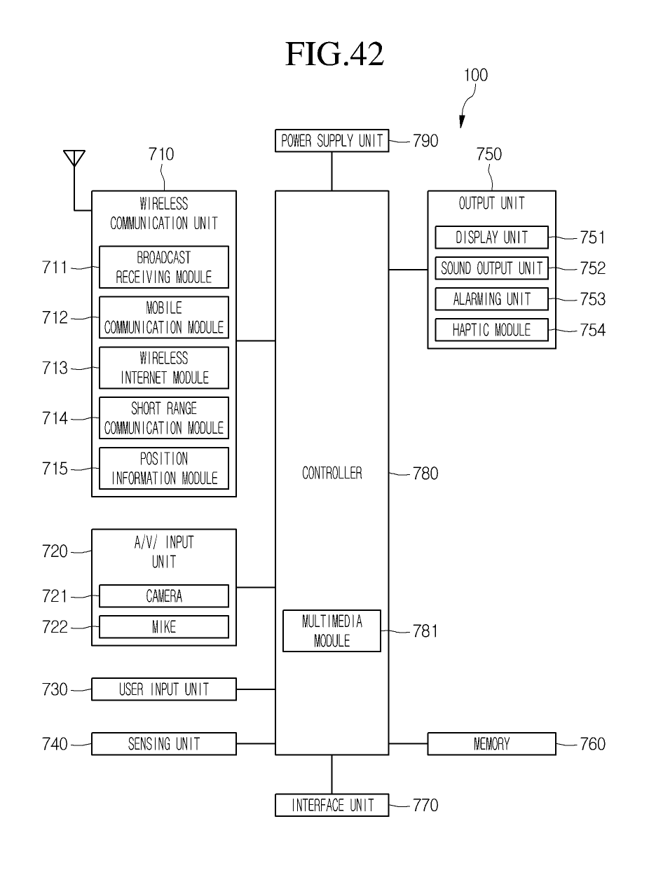

FIG. 42 is a block diagram illustrating a configuration of a control device according to an embodiment of the present invention. As one example of the control device 100 used as a CP, a configuration of a portable terminal is shown.

Referring to FIG. 42, the control device 100 may include a wireless communication unit 710, an Audio/Video (A/V) input unit 720, a user input unit 730, a sensing unit 740, an output unit 750, a memory 760, an interface unit 770, a controller 780, and a power supply unit 790. Since the components shown in FIG. 42 are not essential, the control device 100 including more or less components may be realized.

The wireless communication unit 710 may include at least one module allowing wireless communication between the control device 100 and a wireless communication system or between the control device 100 and a network including the control device 100. For example, the wireless communication unit 710 may include at least one broadcast receiving module 711, at least one mobile communication module 712, at least one wireless internet module 713, at least one short-range communication module 714, and at least one position information module 715.

The control device 100 may access a network through the communication module.

Especially, according to an embodiment of the present invention, the wireless communication unit 710 may transmit/receive the message or device information through multicast or unicast in response to a control of the controller 780. The collected device information is stored in the memory 760.

The broadcast receiving module 711 receives a broadcast and/or broadcast related information from an external broadcast management server through a broadcast channel.

The broadcast channel may include a satellite channel and a terrestrial channel. The broadcast management server may mean a server generating and transmitting a broadcast signal and/or broadcast related information or a server receiving a pre-generated broadcast signal and/or broadcast related information and transmitting them to a terminal. The broadcast signal may include a TV broadcast signal, a radio broadcast signal, and a data broadcast signal, and also include a broadcast signal combining a TV broadcast signal or a radio broadcast signal with a data broadcast signal.

The broadcast related information may mean information relating to a broadcast channel, a broadcast program, or a broadcast service provider. The broadcast related information may be provided through a mobile communication network. In this case, the broadcast related information may be received by the mobile communication module 712.

The broadcast related information may exist in various forms. For example, the broadcast related information may exist in forms such as Electronic Program Guide (EPG) of Digital Multimedia Broadcasting (DMB) or Electronic Service Guide (ESG) of Digital Video Broadcast-Handheld (DVB-H).

The broadcast receiving module 711 may receive a digital broadcast signal by using a digital broadcast system such as Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), or Integrated Services Digital Broadcast-Terrestrial (ISDB-T). Of course, the broadcast receiving module 711 may be configured to be proper for another broadcast system in addition to the digital broadcast system.

The broadcast signal and/or broadcast related information received through the broadcast receiving module 711 may be stored in the memory 760.

The mobile communication module 712 transmits/receives a wireless signal to/from at least one of a base station, an external terminal, and a server on a mobile communication network. The wireless signal may include various forms of data according to a voice call signal, a video call signal, or text/multimedia message transmission.

The wireless internet module 713 is a module for wireless internet access, and may be internally or externally included in the control device 100. As wireless internet technology, there are Wireless LAN (WLAN) (Wi-Fi), Wireless broadband (Wibro), World Interoperability for Microwave Access (Wimax), and High Speed Downlink Packet Access (HSDPA).

The short-range communication module 714 refers to a module for short-range communication. As short range communication technology, there are Bluetooth, Radio Frequency Identification (RFID), infrared Data Association (IrDA), Ultra Wideband (UWB), and ZigBee.

The position information module 715 is a module for obtaining the position of a terminal, and its representative example includes a Global Position System (GPS) module.

The A/V input unit 720 is to input an audio signal or a video signal, and may include a camera 721 and a mike 722. The camera 721 processes a video frame such as a still image or a moving image obtained by an image sensor in a video call mode or a capture mode. The processed video frame may be displayed on a display unit 751.

The video frame processed by the camera 721 may be stored in the memory 760 or may be transmitted to the outside through the wireless communication unit 710. The camera 721 may be provided two according to a usage environment.

The mike 722 receives an external sound signal through a microphone in a call mode, a recoding mode, or a voice recognition mode and processes it as voice data. In the case of a call mode, the processed voice data may be converted into a format that can be sent to a mobile communication base station and then outputted through the mobile communication module 712. The mike 722 may have various noise reduction algorithms to remove noise occurring while an external sound signal is inputted.

The user input unit 730 generates input data to allow a user to control an operation of a terminal. The user input unit 730 may include a key pad, a dome switch, a touch pad (static pressure/electrostatic), a jog wheel, and a jog switch.

The sensing unit 740 detects a current state of the control device 100 such as an open/close state of the control device 100, a position of the control device 100, user contact, an orientation of a terminal, and an acceleration/deceleration of a terminal and then generates a sensing signal to control an operation of the control device 100. For example, when the control device 100 has a slide phone, whether the slide phone is opened/closed may be sensed. Additionally, the sensing unit 740 may sense power supply of the power supply unit 790 and external device connection of the interface unit 770. Moreover, the sensing device 740 may include a proximity sensor 741.

The output unit 750 generates a visual, auditory, and tactile related output and may include a display unit 751, a sound output module 752, an alarming unit 753, and a haptic module 754.

The display unit 751 displays (outputs) information processed in the control device 100. For example, when a terminal is in a call mode, a call related User Interface (UI) or Graphic User Interface (GUI) is displayed. When the control device 100 is in a video call mode, or a capture mode, a captured or/and received image, UI, or GUI is displayed.

The display unit 751 may include at least one of a liquid crystal display (LCD), a thin film transistor-liquid crystal display (a TFT LCD), an organic light-emitting diode (OLED), a flexible display, and a 3D display.

Among them, some displays may be a transparent or light transmissive type so that it is possible to see the outside through them. This may be called a transparent display, and its representative example includes a Transparent OLED (TOLED). The display unit 751 may have a rear structure or a light transmissive type structure. Due to such a structure, a user may see an object at the rear of the terminal body through an area that the display unit 741 of the terminal body occupies.

According to an implementation form of the control device 100, at least two display units 75 may exist. For example, a plurality of display units are separately or integrally disposed at one side or different sides, respectively, in the control device 100.

When the display unit 751 and a sensor sensing a touch operation (hereinafter, referred to as a ‘touch sensor’) constitute a mutual layer structure (hereinafter, referred to as a ‘touch screen’), the display unit 751 may be used as an input device addition to an output device. The touch sensor may have a form such as a touch film, a touch sheet, or a touch pad.

The touch sensor is configured to covert a pressure applied to a specific portion of the display unit 751, or a change in capacitance occurring at a specific portion of the display unit 751 into an electrical input signal. The touch sensor may be configured to sense a pressure at the time of touch in addition to a touched position and area.

When there is touch input on the touch sensor, signal(s) corresponding thereto may be sent to a touch controller. The touch controller processes the signal(s) and transmits corresponding data to the controller 780. By doing so, the controller 780 recognizes which area of the display unit 751 is touched.

A proximity sensor 741 may be disposed at an inner area of a terminal surrounded by the touch screen or near the touch screen. The proximity sensor 741 is a sensor sensing an object approaching a predetermined detection surface or an object present in the vicinity by using the force of an electromagnetic field or infrared, without mechanical contact. The proximity sensor 741 has a longer lifecycle and better usability than a contact type sensor.

The proximity sensor 741 may include a transmissive photoelectric sensor, a direct reflective photoelectric sensor, a mirror reflective photoelectric sensor, a high-frequency oscillation proximity sensor, a capacitive proximity sensor, a magnetic proximity sensor, and an infrared proximity sensor. When the touch screen is an electrostatic type, it is configured to sense the proximity of a pointer with a change in electric field according to the proximity of the pointer. In this case, the touch screen (or the touch sensor) may be classified as a proximity sensor.

Hereinafter, for convenience of description, an action for allowing the pointer on the touch screen is recognized when the pointer is close to but does not contact the touch screen is called “proximity touch”, and an action for allowing the pointer to actually contact the touch screen is called “contact touch”. A position for the proximity touch of the pointer on the touch screen is a position where the pointer vertically corresponds to the touch screen during the proximity touch of the pointer.

The proximity sensor senses a proximity touch and a proximity touch pattern (for example, a proximity touch distance, a proximity touch direction, a proximity touch speed, a proximity touch time, a proximity touch position, and a proximity touch moving state, and so on). Information corresponding to the sensed proximity touch operation and proximity touch pattern may be outputted on a touch screen.

The sound output module 752 may output audio data received from the wireless communication unit 710 or stored in the memory 760, in a call signal receiving mode, a call mode, a recording mode, a recording mode, a voice recognition mode, or a broadcast receiving mode. The sound output module 752 may output a sound signal relating to a function of the control device 100 (for example, call signal receiving sound, and message receiving sound). The sound output module 752 may include a receiver, a speaker, and a buzzer.

The alarming unit 753 outputs a signal for notifying event occurrence of the control device 100. An example of an event occurring in a terminal may include call signal reception, message reception, key signal input, and touch input. The alarming unit 753 may output a signal for notifying event occurrence with vibration, besides a video signal or an audio signal. The video signal or audio signal may be outputted through the display unit 751 or the sound output module 752, so that they 751 and 752 may be classified as part of the alarming unit 753.

The haptic module 754 may generate various tactile effects that a user can feel. A typical example of a tactile effect that the haptic module 754 generates includes vibration. The intensity and pattern of a vibration generated by the haptic module 754 is controllable. For example, different vibrations may be synthesized and outputted or may be sequentially outputted.

The haptic module 754 may generate various tactile effects such as pin arrangement that vertically moves with respect to contact skin surface, injection power or suction power of air through a nozzle or an inlet, graze on a skin surface, contact of an electrode, effect by stimuli such as electrostatic force, and effect by cold/warm reproduction using a heat absorbing or generating device.

The haptic module 754 may deliver tactile effects through direct contact, and a user may feel tactile effect through muscle sense such as fingers or hands. The haptic module 754 may be provided two according to a configuration aspect.

The memory 760 may store a program for an operation of the controller 780, and may temporarily store input/output data (for example, a phonebook, a message, a still image, and a moving image). The memory 760 may store data relating to various patterns of vibrations and sounds, which are outputted during touch input on the touch screen.

The memory 760 may include at least one type of storage medium among a flash memory type, a hard disk type, a multimedia card micro type, card type memory (for example, SD or XD memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, and optical disk. The control device 100 may operate in relation to a web storage performing the storage function of the memory 760 on internet.

The interface unit 770 serves as a path with all external devices connected to the control device 100. The interface unit 770 receives data from an external device or power, and then delivers it to each component in the control device 100 or transmits data in the control device 100 to an external device. For example, the interface unit 770 includes a wired/wireless headset port, an external charging port, a wired/wireless data port, a memory card port, a port connecting a device equipped with an identification module, an audio input/output (I/O) port, a video input/output (I/O) port, and an earphone port.

The identification module is a chip storing various information to authenticate the permission of the control device 100, and may include a User Identify Module (UIM), a Subscriber Identity Module (SIM), and a Universal Subscriber Identity Module (USIM). A device equipped with an identification module (hereinafter, referred to as an “identification device’) may be manufactured with a smart card type. Accordingly, an identification device may be connected to a terminal through a port.

When a terminal is connected to an external cradle, the interface unit may be a path through which power is supplied from the cradle to the terminal, or various command signals inputted from the cradle are delivered to the terminal. Various command signals or power inputted from the cradle may operate as a signal for recognizing that the terminal is accurately mounted on the cradle.

The controller 180 controls overall operations of a terminal in general. For example, control and processing relating to a voice call, a data call, a video call are performed. The control unit 780 may include a multimedia module 781 for multimedia playback. The multimedia module 781 may be implemented in the controller 780 or may be separated from the controller 780.

According to an embodiment of the present invention, the controller 780 may perform the judgment and determination described with reference to FIGS. 1 to 41, and in more detail, the controller 780 controls the wireless communication unit 710 and performs the operations described with reference to FIGS. 1 to 42.

For example, the wireless communication unit 710 receives CEC address information from at least one among UPnP devices discovered by an UPnP discovery protocol, and the controller 780 checks an HDMI connection between a source device and a sink device among the discovered UPnP devices by using the received CEC address information and controls content to be streamed through the HDMI connection between the source device and the sink device.

Additionally, the controller 780 may perform pattern recognition processing to recognize writing input and drawing input on the touch screen as text and images, respectively.

The power supply unit 790 supplies power necessary for operations of each component by receiving external power and internal power in response to a control of the controller 780.

FIG. 42 is a view illustrating a configuration of the control device 100. The present invention is not limited thereto. The controlled device, for example, the HDMI source 110 and the HDMI sink 120, may have the same configuration described with reference to FIG. 42.

According to another embodiment of the present invention, the control device 100, i.e., a CP, may determine an interface to transmit/receive content from among a plurality of interfaces, and may determine the interface by using information obtained through the operations described with reference to FIGS. 1 to 41.

For example, when a content in the HDMI source 110 is streamed to the HDMI sink 120, the control device 100 determines whether to stream the content through an IP based interface such as WiFi defined in an existing UPnP or an HDMI.

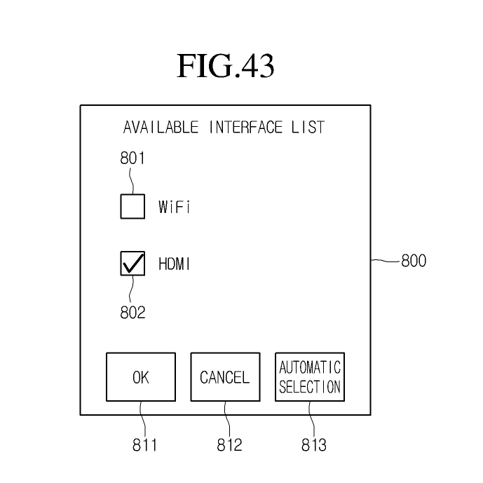

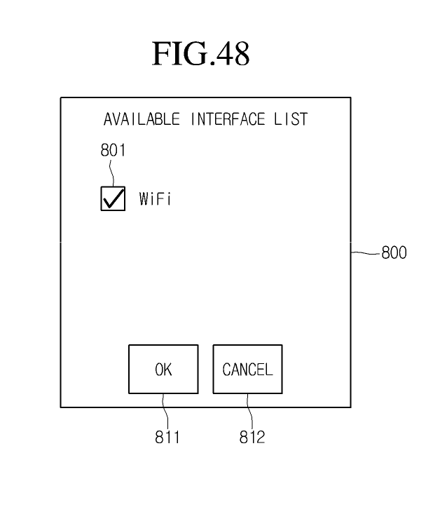

Hereinafter, a method of determining an interface for transmitting content will be described in more detail with reference to FIGS. 43 to 51 according to embodiments of the present invention.

In relation to a method of determining the interface according to a first embodiment, the control device 100 provides to a user the information on at least one available interface for content streaming in connection between the HDMI source 110 and the HDMI sink 120, and receives a selection on one available interface from a user to determine the interface for streaming corresponding content.

Referring to FIG. 43, when a user selects one of contents in the HDMI source 110 and plays it in the HDMI sink 120, a list of available interfaces for streaming the selected content may be displayed on a display screen 800 of the control device 100.

Moreover, according to the method described with reference to FIGS. 1 to 41, the list of available interfaces may be generated based on information obtained by the control device 100, for example, information on whether an HDMI is connected between the HDMI source 110 and the HDMI sink 120 and information on whether the HDMI source 110 and the HDMI sink 120 can decode a target content, which are checked through CEC address information.

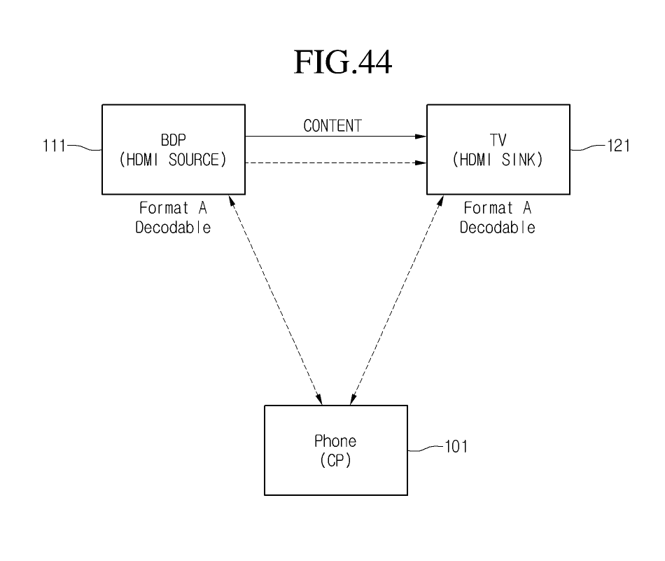

As shown in FIG. 44, when the BDP 111, i.e., an HDMI source, and the TV 121, i.e., an HDMI sink, are connected through HDMI, and a content that a user selects can be decoded by the BDP 111 and the TV 121, both IP based WiFi and non-IP based HDMI may be used as an interface to stream the content.

Accordingly, a user selects an interface from an interface list displayed on a screen 800 of the control device 100 and transmits content in the BDP 111 to the TV 121 through the selected interface to be played in the TV 121.

For example, a user checks and selects one 802 of select boxes 801 and 802 corresponding to “HDMI” among the available interfaces displayed on the screen 800, and then selects an OK button 811, so that content in the BDP 111 is streamed into the TV 121 through an HDMI connection.

Moreover, when a user selects an automatic select button 813, the control device 100 may select one of available interfaces displayed on the screen 800 according to a predetermined standard.

In the interface automatic selection of the control device 100, an HDMI may have a higher priority than an IP based interface defined in the existing UPnP such as WiFi.

In order to determine the interface according to an embodiment of the present invention, the control device 100 may determine an interface for transmitting/receiving the content on the basis of bandwidth saving policy according to a network bandwidth of an IP based interface.

For example, when a bandwidth of a WiFi network for streaming the content of the HDMI source 110 to the HDMI sink 120 is reduced less than a standard value and thus is not sufficient for content streaming, the control device 100 may select an HDMI as an interface for the content streaming.

According to another embodiment of the present invention, the control device 100 may determine an interface for transmitting/receiving the content on the basis of hop saving policy according to the number of hops necessary for streaming the content.

For example, when the number of hops necessary for streaming the content of the HDMI source 110 to the HDMI sink 120 through an IP based interface such as WiFi is less than the number of hops necessary for streaming the content through an HDMI (i.e., in the case of WiFi content streaming, the number of devices passing through is less), the control device 100 may select WiFi as an interface for the content streaming.

According to another embodiment, the control device 100 may determine an interface for transmitting/receiving the content according to whether a target content of each of devices discovered by an UPnP discovery protocol can be decoded.

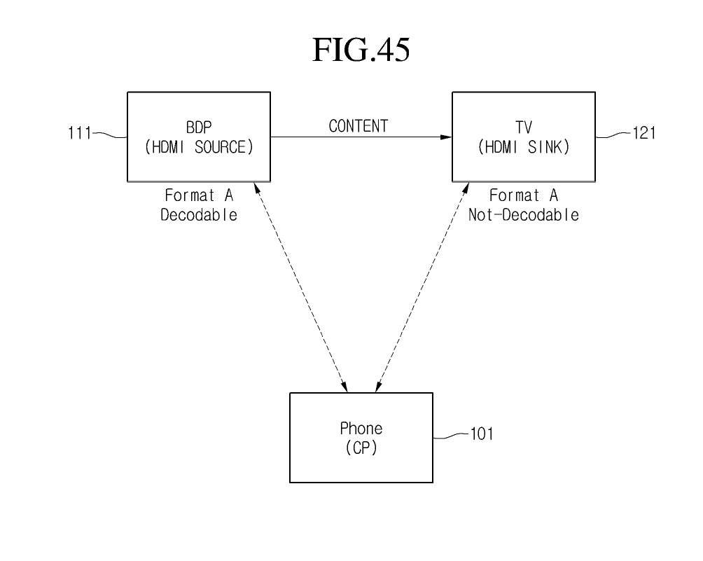

For example, as shown in FIG. 45, when the TV 121, i.e., an HDMI sink, for playing content is not equipped with codec proper for decoding corresponding content and the BDP 111, i.e., an HDMI source, is equipped with codec proper for decoding corresponding content, the Phone 101, i.e., a CP, may select an HDMI as an interface for streaming the content.

In this case, the Phone 101 turns on an HDMI session between the BDP 111 and the TV 121 by using the UPnP control messages, and controls the content to be played in the BDP 111.

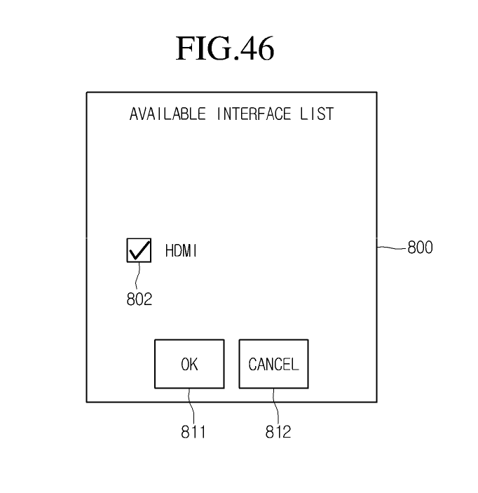

In the above case, since the BDP 111 does not transmit the decoded content to the TV 121 through an IP based interface such as WiFi, as shown in FIG. 46, an available interface list provided to a user through the screen 800 of the control device 100 may include only an HDMI.

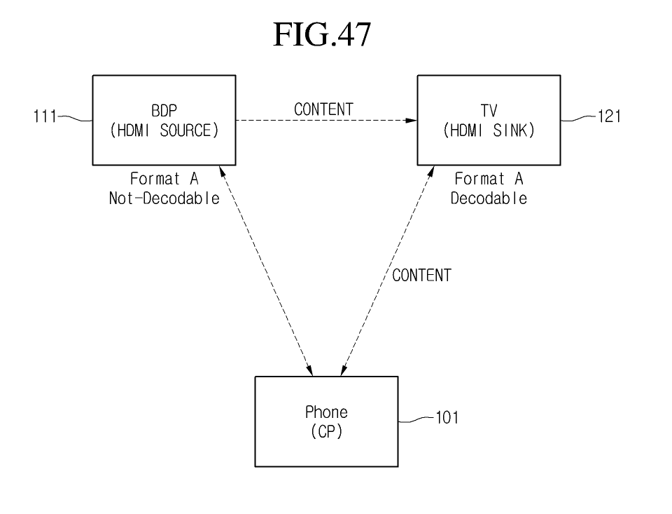

As shown in FIG. 47, when the TV 121, i.e., an HDMI sink, for playing content is equipped with codec proper for decoding corresponding content and the BDP 111, i.e., an HDMI source, is not equipped with codec proper for decoding corresponding content, the Phone 101, i.e., a CP, may select an IP based interface such as WiFi as an interface for streaming the content.

In the above case, since the BDP 111 cannot decode content and transmit it to the TV 121 through an HDMI, as shown in FIG. 47, an available interface list provided to a user through the screen 800 of the control device 100 may include only an IP based interface such as WiFi.

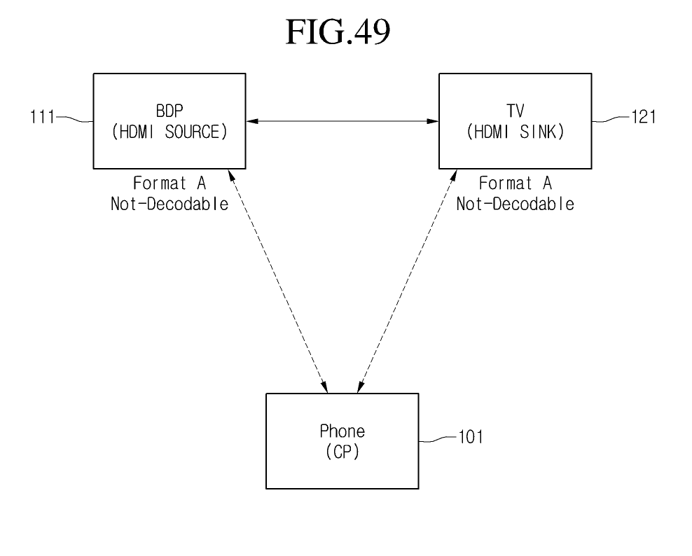

As shown in FIG. 49, when both the TV 121, i.e., an HDMI sink and the BDP 111, i.e., an HDMI source, are not equipped with codec proper for decoding corresponding content, the Phone 101, i.e., a CP, may determine that the content cannot be played in the TV 121.

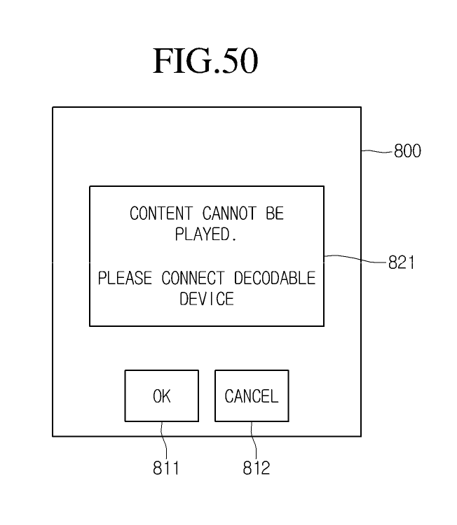

In this case, as shown in FIG. 50, a message for notifying a user that a content of the BDP 111 that a user selects through the screen 800 of the control device 100 cannot be played in the TV 121 may be displayed with a pop-up window 821.

Moreover, in order to play the content of the BDP 111 in the TV 121, a user additionally connects an MS having codec proper for decoding the target content to a network, so that the content is relayed through the connected new MS to be streamed to the TV 121.

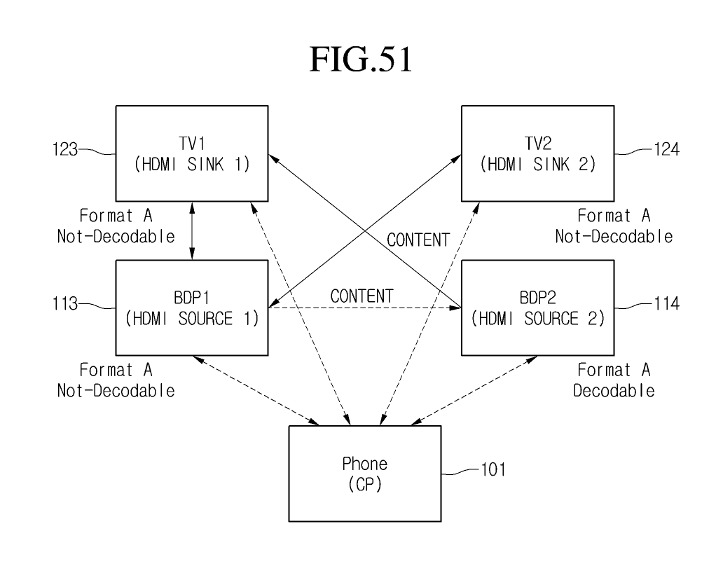

As shown in FIG. 51, when both the TV1 123, i.e., an HDMI sink, for playing content and the BDP1 113, i.e., an HDMI source, having content to be streamed are not equipped with codec proper for decoding corresponding content and the BDP2 114, i.e., another HDMI source, is equipped with codec proper for decoding corresponding content, the Phone 101, i.e., a CP, may relay the content of the BDP1 through the BDP2 to be played in the TV 121.

In this case, the Phone 101 turns on an HDMI session between the BDP2 114 and the TV1 123 by using the UPnP control messages, and controls the content of the BDP1 113 to be played in the BDP2 114.

Moreover, as shown in FIGS. 43 to 51, a content in the HDMI source 110 is played in the HDMI sink 120 according to an embodiment of the present invention. However, the above interface and streaming route determining method may be used when the control device 100 performs a function of the MS to transmit the content in the control device to the TV 121 in order for streaming.

Various embodiments described herein may be realized in a computer or device similar thereto readable recording medium by using software, hardware, or a combination thereof.

In terms of hardware realization, the embodiments described herein may be realized by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing other functions. In some cases, such embodiments may be realized by the controller 780.

Examples of the computer readable recording medium include read-only memory (ROM), random-access memory (RAM), CD-ROMs, magnetic tapes, floppy disks, and optical data storage devices, and carrier waves (such as data transmission through the Internet).

The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims.

1. A method of controlling content transmission between Universal Plug and Play (UPnP) devices, the method comprising:
discovering a plurality of UPnP devices;
receiving, from at least one of the discovered UPnP devices, a Consumer Electronics Control (CEC) address of the UPnP device and a CEC address of a device which is connected to the UPnP device through a High Definition Multimedia Interface (HDMI);
checking, by using the received CEC addresses, an HDMI connection between a source device and a sink device among the discovered UPnP devices; and
controlling content to be streamed through the HDMI connection between the source device and the sink device.

2. The method of claim 1, wherein receiving the CEC address comprises:
requesting transmission of CEC address information to each of the discovered UPnP devices by using Internet Protocol (IP) addresses obtained during discovering the plurality of UPnP devices.

3. The method of claim 1, further comprising:
checking whether the discovered UPnP devices can decode the content to be streamed.

4. The method of claim 3, wherein checking whether the discovered UPnP devices can decode the content to be streamed comprises:
requesting transmission of supportable content format information to each of the discovered UPnP devices.

5. The method of claim 1, wherein controlling the content to be streamed comprises:
turning on or off an HDMI session between the source device and the sink device.

6. The method of claim 5, wherein turning on or off of the HDMI session comprises:
transmitting an UPnP control message for turning on or off the HDMI session to at least one of the source device and the sink device, wherein a CEC message corresponding to the transmitted UPnP control message is transmitted/received through the HDMI connection between the source device and the sink device.

7. The method of claim 1, wherein controlling the content to be streamed comprises:
controlling content streaming from the source device to the sink device.

8. The method of claim 7, wherein controlling the content streaming comprises:
transmitting an UPnP control message for performing one of play, stop, and pause for the content to at least one of the source device and the sink device, wherein a CEC message corresponding to the transmitted UPnP control message is transmitted/received through the HDMI connection between the source device and the sink device.

9. The method of claim 1, wherein controlling the content to be streamed comprises:
decoding a content that the source device receives from a Media Server (MS) among the discovered UPnP devices, to control the decoded content to be streamed to the sink device through the HDMI connection.

10. The method of claim 9, wherein the MS is a device that is not capable of decoding the content or is not connected to the sink device through an HDMI.

11. The method of claim 11, wherein the source device includes an MS and a Media Renderer (MR), and the sink device includes an MR.

12. The method of claim 1, further comprising:
determining an interface for transmitting/receiving the content as one of an IP based interface and the HDMI.

13. The method of claim 12, wherein determining the interface comprises:
providing information on at least one interface connectable between the source device and the sink device; and
receiving a selection on one of the connectable interfaces from a user.

14. The method of claim 12, wherein determining the interface comprises:
determining an interface for transmitting/receiving the content according to a network bandwidth of the IP based interface.

15. The method of claim 12, wherein determining the interface comprises:
determining an interface for transmitting/receiving the content according to whether the source device and the sink device can decode the content.

16. A device of controlling content transmission between UPnP devices, the device comprising:
a communication unit receiving CEC address information from at least one of discovered UPnP devices; and
a controller checking an HDMI connection between a source device and a sink device among the discovered UPnP devices by using the received CEC address information and controlling a content to be streamed through the HDMI connection between the source device and the sink device,
wherein the CEC address information comprises a CEC address of the UPnP device and a CEC address of a device connected to the UPNP device through an HDMI.

17. The device of claim 16, wherein the communication unit receives information on a supportable content format from the discovered UPnP devices.

18. The device of claim 16, wherein the communication unit transmits an UPnP control device for turning on or off an HDMI session between the source device and the sink device, wherein a CEC message corresponding to the transmitted UPnP control message is transmitted/received through the HDMI connection between source device and the sink device.

19. The device of claim 16, wherein the communication unit transmits an UPnP control message for performing one of play, stop, and pause for the content to at least one of the source device and the sink device, wherein a CEC message corresponding to the transmitted UPnP control message is transmitted/received through the HDMI connection between the source device and the sink device.

20. The device of claim 16, wherein the control unit decodes a content that the source device receives from an MS among the discovered UPnP devices, and controls the decoded content to be streamed the sink device through the HDMI connection.
